(19) United States
(12) Patent Application Publication
(10) Pub. No.: US 2025/0323732 A1
(43) Pub. Date: Oct. 16, 2025

(54) ESTIMATION APPARATUS, ESTIMATION METHOD AND PROGRAM

(71) Applicant: NIPPON TELEGRAPH AND TELEPHONE CORPORATION, Tokyo (JP)

(72) Inventors: Seiji OKAMOTO, Musashino-shi (JP); Etsushi YAMAZAKI, Musashino-shi (JP); Kengo HORIKOSHI, Musashino-shi (JP)

(73) Assignee: NIPPON TELEGRAPH AND TELEPHONE CORPORATION, Tokyo (JP)

(21) Appl. No.: 18/865,397

(22) PCT Filed: Jun. 3, 2022
(86) PCT No.: PCT/JP2022/022620

§ 371 Date: Nov. 13, 2024

(51) Int. Cl. H04B 10/61

(52) U.S. Cl. CPC H04B 10/6164

(57) ABSTRACT

An estimation device includes: a difference derivation unit that derives a first power difference between a positive frequency component and a negative frequency component of a received signal or derives a second power difference between a positive time component and a negative time component of the received signal; and an offset estimation unit that estimates a frequency offset value of the received signal on the basis of the first power difference or the second power difference. The estimation device may further include a compensation unit that compensates for frequency offset by using the frequency offset value. In a case where there is a plurality of potential frequency offset values, the compensation unit may compensate for the frequency offset of the received signal on the basis of a predetermined offset value.

### TECHNICAL FIELD

The present invention relates to an estimation apparatus, an estimation method and a program.

### BACKGROUND ART

In digital coherent optical communication, a reception device may perform homodyne reception by matching a frequency of laser light used for transmission with a frequency of laser light (local oscillation light) used for reception. A shift value (frequency offset value) between the frequency of the laser light used for transmission and the frequency of the laser light used for reception generally falls within a range of ±5 GHz. For example, in a standard “400ZR” defined by a standardization organization “OIF (The Optical Internetworking. Forum)”, the shift value is defined to be fall within a range of ±3.6 GHz.

In demodulation of a received signal, it is necessary to estimate a frequency offset value of the received signal and compensate for frequency offset on the basis of the estimation result of the frequency offset. In the frequency offset estimation, for example, the frequency offset value is estimated by using a fourth power law using a distribution characteristic of quadrature phase shift keying (QPSK) signals. Therefore, in many cases, the frequency offset value is estimated after the frequency offset is compensated for by using an adaptive filter (see Non Patent Documents 1, 2, and 3). Here, the frequency offset value is estimated within an applicable range of the adaptive filter. Thus, a range in which the frequency offset can be estimated is, for example, approximately 5 GHz in a case where a 100 Gbit/s-class coherent DSP (digital signal processor)-LSI (large scale integrated circuit) is used.

In recent years, digital coherent optical communication has been applied not only to an application of a medium distance such as a distance between cities and an application of a long distance such as a distance between continents, but also to an application of a short distance such as a distance in a data center. In the application of the short distance in particular, it is important that a communication device is small and inexpensive. Therefore, a laser provided in the communication device is required to be small and inexpensive.

### CITATION LIST

### Non Patent Documents

Non Patent Document 1: I. Fatadin and S. J. Savory, “Compensation of Frequency Offset for 16-QAM Optical Coherent Systems Using QPSK Partitioning,” in IEEE Photonics Technology Letters, vol. 23, no. 17, pp. 1246-1248, Sep. 1, 2011, doi: 10.1109/LPT.2011.2158994.

Non Patent Document 2: M. Selmi, Y. Jaouen and P. Ciblat, “Accurate digital frequency offset estimator for coherent PolMux QAM transmission systems,” 2009 35th European Conference on Optical Communication, 2009, pp. 1-2.

Non Patent Document 3: Q. Yan, L. Liu and X. Hong, “Blind Carrier Frequency Offset Estimation in Coherent Optical Communication Systems With Probabilistically Shaped M-QAM,” in Journal of Lightwave Technology, vol. 37, no. 23, pp. 5856-5866, 1 Dec. 1, 2019, doi: 10.1109/JLT.2019.2940770.

### SUMMARY OF INVENTION

### Technical Problem

However, frequency offset of an optical signal generated by using a small and inexpensive laser is wider than that of an optical signal generated by using a large or expensive laser and is, for example, several tens of GHz. In a case where frequency offset of an electrical signal (received signal) converted from a received optical signal is wide, the wide frequency offset generated in a frequency of the received signal cannot be estimated by using a reception device having a simple configuration.

In view of the above circumstances, an object of the present invention is to provide an estimation device, an estimation method, and a program capable of estimating wide frequency offset generated in a frequency of a received signal by using a reception device having a simple configuration.

### Solution to Problem

An aspect of the present invention is an estimation device including: a difference derivation unit that derives a first power difference between a positive frequency component and a negative frequency component of a received signal or derives a second power difference between a positive time component and a negative time component of the received signal; and an offset estimation unit that estimates a frequency offset value of the received signal on the basis of the first power difference or the second power difference.

An aspect of the present invention is an estimation method performed by an estimation device, the estimation method including: a step of deriving a first power difference between a positive frequency component and a negative frequency component of a received signal or deriving a second power difference between a positive time component and a negative time component of the received signal; and a step of estimating a frequency offset value of the received signal on the basis of the first power difference or the second power difference.

An aspect of the present invention is a program for causing a computer to execute: a procedure of deriving a first power difference between a positive frequency component and a negative frequency component of a received signal or deriving a second power difference between a positive time component and a negative time component of the received signal; and a procedure of estimating a frequency offset value of the received signal on the basis of the first power difference or the second power difference.

### Advantageous Effects of Invention

According to the present invention, it is possible to estimate wide frequency offset generated in a frequency of a received signal by using a reception device having a simple configuration.

### BRIEF DESCRIPTION OF DRAWINGS

FIG. 1 shows a configuration example of a communication system in a first embodiment.

FIG. 2 shows a configuration example of a demodulation unit in the first embodiment.

FIG. 3 shows an example of frequency spectra of a received signal in the first embodiment.

FIG. 4 shows an example of a relationship between frequency offset and power difference in the first embodiment.

FIG. 5 is a flowchart showing an operation example of a reception device in the first embodiment.

FIG. 6 shows a configuration example of a demodulation unit in a second embodiment.

FIG. 7 shows a configuration example of a demodulation unit in a third embodiment.

FIG. 8 shows a configuration example of a demodulation unit in a fourth embodiment.

FIG. 9 shows a configuration example of a demodulation unit in a fifth embodiment.

FIG. 10 shows a configuration example of a demodulation unit in a sixth embodiment.

FIG. 11 shows a configuration example of a demodulation unit in a seventh embodiment.

FIG. 12 shows a configuration example of a demodulation unit in an eighth embodiment.

FIG. 13 shows a configuration example of a demodulation unit in a ninth embodiment.

FIG. 14 shows a configuration example of a demodulation unit in a tenth embodiment.

FIG. 15 shows a configuration example of a demodulation unit in an eleventh embodiment.

FIG. 16 shows a configuration example of a demodulation unit in a twelfth embodiment.

FIG. 17 shows a configuration example of a demodulation unit in a thirteenth embodiment.

FIG. 18 shows a configuration example of a demodulation unit in a fourteenth embodiment.

FIG. 19 shows a configuration example of a demodulation unit in a fifteenth embodiment.

FIG. 20 shows a configuration example of a demodulation unit in a sixteenth embodiment.

FIG. 21 shows an example of frequency spectra of a received signal in a seventeenth embodiment.

FIG. 22 shows an example of a peak of a power difference in the seventeenth embodiment.

FIG. 23 is a flowchart showing an operation example of a reception device in the seventeenth embodiment.

FIG. 24 shows an example of dependency of a power difference on an FFT size (the number of samples) in the seventeenth embodiment.

FIG. 25 shows an example of a data table for each roll-off value of a Nyquist filter in the seventeenth embodiment.

FIG. 26 shows a hardware configuration example of a reception device in each embodiment.

### DESCRIPTION OF EMBODIMENTS

Embodiments of the present invention will be described in detail with reference to the drawings.

### First Embodiment

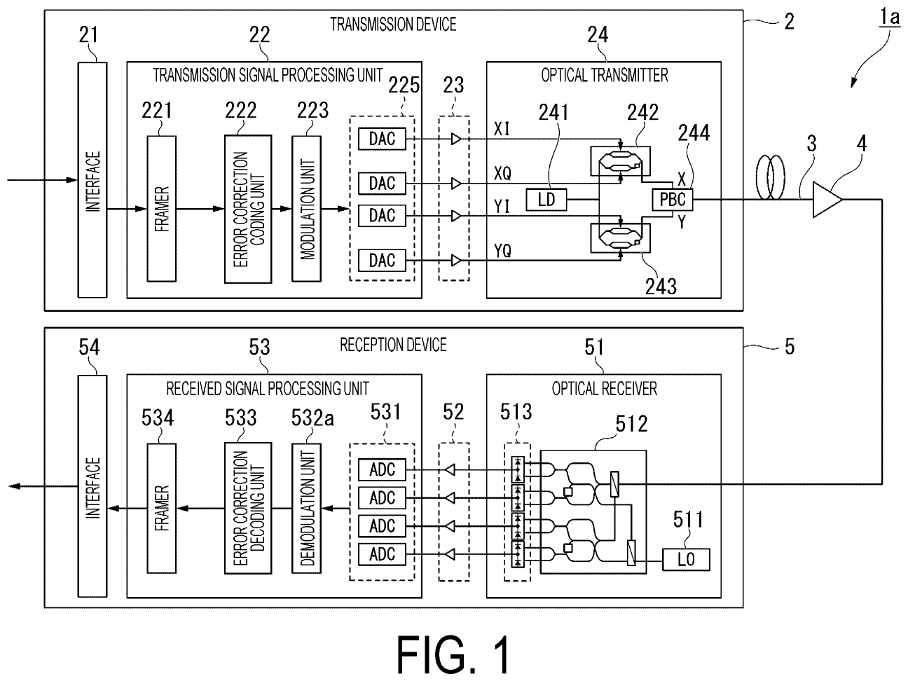

FIG. 1 shows a configuration example of a communication system 1a in a first embodiment. The communication system 1a performs communication by using an optical signal. The communication system 1a includes a transmission device 2, an optical fiber 3, one or more (e.g. four) amplifiers 4, and a reception device 5. Here, the communication system 1a includes the optical fiber 3 and the amplifier 4 as a transmission line of an optical signal.

First, the transmission device 2 will be described.

The transmission device 2 includes an interface 21, a transmission signal processing unit 22, a modulator driver group 23, and an optical transmitter 24. The transmission signal processing unit 22 includes a framer 221, an error correction coding unit 222, a modulation unit 223, and a digital-to-analog converter group 224. The optical transmitter 24 includes a laser diode 241, an X-polarization optical converter 242, a Y-polarization optical converter 243, and a polarization beam combiner 244.

The interface 21 is an electrical interface on a client (user) side. The interface 21 outputs a client signal (user signal) to be transmitted to the transmission signal processing unit 22.

The transmission signal processing unit 22 is a functional unit that performs predetermined processing on the client signal to be transmitted. The framer 221 converts the client signal into a transmission signal having a predetermined frame format. The error correction coding unit 222 performs predetermined error correction coding processing on the transmission signal.

The modulation unit 223 performs predetermined modulation processing on the transmission signal subjected to the error correction coding. The digital-to-analog converter (DAC) group 224 converts the transmission signal (analog signal) subjected to the modulation processing into transmission signals that are digital signals (X-polarized I channel signal “XI”, X-polarized Q channel signal “XQ”, Y-polarized I channel signal “YI”, and Y-polarized Q channel signal “YQ”). The modulator driver group 23 (optical modulator driver amplifiers) amplifies power of the transmission signals that are the digital signals (electrical signals).

The optical transmitter 24 transmits an optical signal. The laser diode (LD) 241 outputs laser light having a predetermined frequency to the X-polarization optical converter 242 and the Y-polarization optical converter 243. The X-polarization optical converter 242 generates an X-polarized wave according to the X-polarized I channel signal and the X-polarized Q channel signal by using laser light. The Y-polarization optical converter 243 generates a Y-polarized wave according to the Y-polarized I channel signal and the Y-polarized Q channel signal by using laser light.

The polarization beam combiner 244 combines polarized waves whose planes of polarization are orthogonal to each other. That is, the polarization beam combiner 244 combines the X-polarized wave and the Y-polarized wave. The polarization beam combiner 244 transmits an optical signal of the combined polarized waves to the reception device 5 by using the transmission line. In the transmission line, the optical fiber 3 transmits the optical signal. In the transmission line, the amplifier 4 amplifies power of the optical signal.

Next, the reception device 5 will be described.

The reception device 5 includes an optical receiver 51, a transimpedance amplifier group 52, a received signal processing unit 53, and an interface 54. The optical receiver 51 includes a local oscillator 511, a signal extraction circuit 512, and a detector 513. The received signal processing unit 53 includes an analog-to-digital converter group 531, a demodulation unit 532a, an error correction decoding unit 533, and a framer 534.

The optical receiver 51 receives an optical signal. The local oscillator 511 (LO) outputs local oscillation light (laser light) having a predetermined frequency to the signal extraction circuit 512. The signal extraction circuit 512 is a circuit (functional unit) which extracts a received signal and is, for example, a 90 degree optical hybrid circuit. The 90 degree optical hybrid circuit includes a polarization beam splitter (PBS). The signal extraction circuit 512 mixes the optical signal received by the polarization beam splitter with the local oscillation light output from the local oscillator 511.

Therefore, the signal extraction circuit 512 extracts an in-phase component (I) and a quadrature component (Q) of an electric field from the received optical signal.

The detector 513 detects the X-polarized I channel signal and Q channel signal and the Y-polarized I channel signal and Q channel signal from the mixing result (extraction result). The detector 513 is, for example, a balanced photodetector. The detector 513 outputs received signals (electrical signals) of a current according to the detection result to the analog-to-digital converter (ADC) group 531.

The transimpedance amplifier group 52 converts the current of the received signals output from the detector 513 into a voltage. The transimpedance amplifier group 52 outputs the received signals to the received signal processing unit 53 on the basis of the conversion result. The received signal processing unit 53 performs predetermined signal processing on the received signals. The analog-to-digital converter group 531 converts the received signals (analog signals) according to the voltage into a digital received signal.

The demodulation unit 532a performs predetermined demodulation processing on the digital received signal. Here, the demodulation unit 532a (estimation device) estimates a frequency offset value in the received signal. The demodulation unit 532a (compensation device) compensates for frequency offset in the received signal on the basis of the estimated frequency offset value. Further, the demodulation unit 532a demodulates the received signal by performing predetermined signal processing. The predetermined signal processing is, for example, polarization separation and frequency characteristic compensation by adaptive equalization, wavelength dispersion compensation, or phase compensation.

The error correction decoding unit 533 performs predetermined error correction decoding processing on the received signal subjected to the demodulation processing. The framer 534 converts the received signal into a client signal (user signal) on the basis of the frame format of the received signal. The interface 54 is an electrical interface on the client (user) side. The interface 54 outputs the received client signal (user signal) to a user device (not shown).

Next, the demodulation unit 532a will be described.

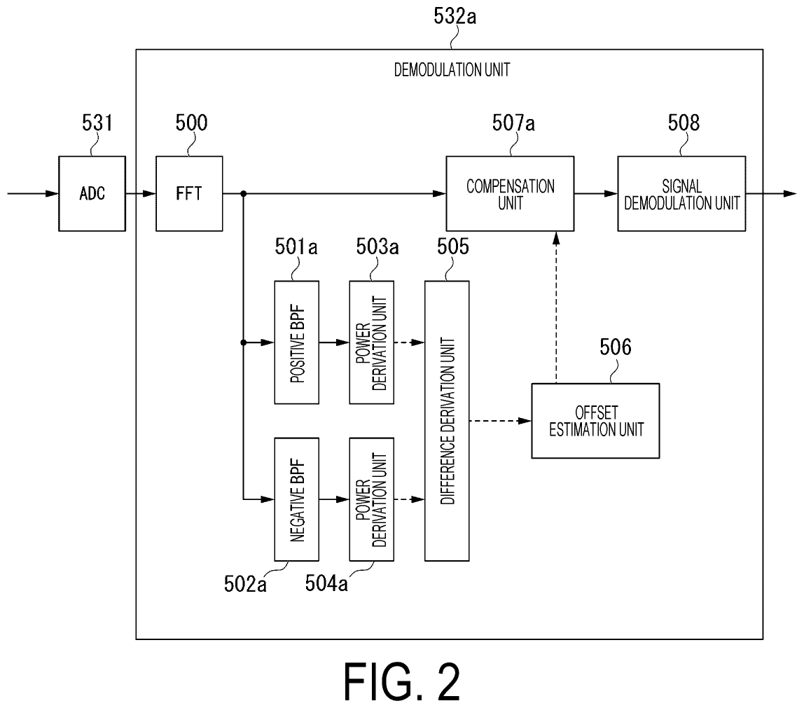

FIG. 2 shows a configuration example of the demodulation unit 532a in the first embodiment. The demodulation unit 532a includes a fast Fourier transform unit 500, a positive band-pass filter 501a, a negative band-pass filter 502a, a power derivation unit 503a, a power derivation unit 504a, a difference derivation unit 505, an offset estimation unit 506, a compensation unit 507a, and a signal demodulation unit 508.

In the first embodiment, a frequency offset value of a received signal is estimated by using each band-pass filter for positive and negative frequency components in positive and negative frequency domains having a frequency “0” as a reference (boundary between the regions). The compensation unit 507a performs processing of compensating for frequency offset of a received signal on output of the fast Fourier transform unit 500.

The fast Fourier transform unit 500 acquires a digital received signal from the analog-to-digital converter group 531. The fast Fourier transform unit 500 performs fast Fourier transform on the digital received signal. Therefore, the acquired received signal is converted into a received signal in a frequency domain.

The positive band-pass filter 501a extracts a positive frequency component from the received signal in the frequency domain. The positive band-pass filter 501a outputs the extracted positive frequency component to the power derivation unit 503a. The negative band-pass filter 502a extracts a negative frequency component from the received signal in the frequency domain. The negative band-pass filter 502a outputs the extracted negative frequency component to the power derivation unit 504a.

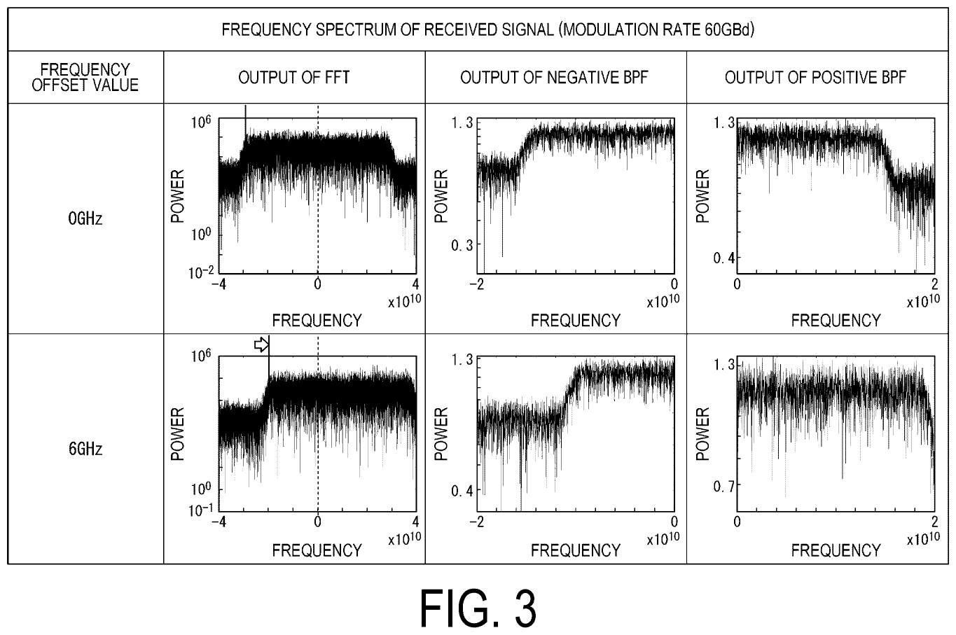

FIG. 3 shows an example of frequency spectra (power spectra) of a received signal in the first embodiment. A modulation rate of the received signal in FIG. 3 is, for example, 60 GBd. In a case where the frequency offset value is “0 GHz”, a power spectrum of the positive frequency component and a power spectrum of the negative frequency component are substantially symmetrical with respect to a frequency “0 GHz”. Meanwhile, in a case where the frequency offset value is other than “0 GHz” (e.g. 6 GHz), the power spectrum of the positive frequency component and the power spectrum of the negative frequency component are asymmetrical with respect to the frequency “0 GHz”.

Returning to FIG. 2, description of the configuration example of the demodulation unit 532a will be continued. The power derivation unit 503a derives a power value of the power spectrum of the extracted positive frequency component. In order to suppress noise, the power derivation unit 503a may acquire the extracted positive frequency component a plurality of times. The power derivation unit 503a may perform averaging processing on the positive frequency components acquired the plurality of times. The averaging processing may be simple averaging processing or averaging processing using a forgetting factor “ρ”. The averaging processing using the forgetting factor “ρ” for the positive frequency component is shown by, for example, Equation (1).

$$\begin{matrix}[ Math . 1 ] & \\ {F}_{abs +} ( f ) = ρ {F}_{a b s +} ( f ) + ( 1 - ρ ) {F}_{a b s +}^{′} ( f ) & ( 1 )\end{matrix}$$

Here, “F_{abs+}(f)” represents an average of squares of absolute values of the positive frequency components acquired the plurality of times (averaged positive frequency component). “F′_{abs+}(f)” represents a square of an absolute value of the positive frequency component acquired once. A power value “P₊” of the power spectrum of the positive frequency component is shown by, for example, Equation (2).

$$\begin{matrix}[ Math . 2 ] & \\ {P}_{+} = \sum ( {F}_{a b s +} ( f ) ) & ( 2 )\end{matrix}$$

The power derivation unit 504a derives a power value of the power spectrum of the extracted negative frequency component. In order to suppress noise, the power derivation unit 504a may acquire a square of an absolute value of the extracted negative frequency component a plurality of times. The power derivation unit 504a may perform averaging processing on the squares of the absolute values of the negative frequency components acquired the plurality of times. The averaging processing using the forgetting factor “ρ” for the square of the absolute value of the negative frequency component is shown by Equation (3).

$$\begin{matrix}[ Math . 3 ] & \\ {F}_{a b s -} ( f ) = ρ {F}_{a b s -} ( f ) + ( 1 - ρ ) {F}_{a b s -}^{′} ( f ) & ( 3 )\end{matrix}$$

Here, “F_{abs-}(f)” represents an average of the squares of the absolute values of the negative frequency components acquired the plurality of times (averaged negative frequency component). “F′_{abs-}(f)” represents the square of the absolute value of the negative frequency component acquired once. A power value “P₋” of the power spectrum of the negative frequency component is shown by Equation (4).

$$\begin{matrix}[ Math . 4 ] & \\ {P}_{-} = \sum ( {F}_{a b s -} ( f ) ) & ( 4 )\end{matrix}$$

The difference derivation unit 505 derives a difference (power difference) between the power value “P₊” of the power spectrum of the positive frequency component and the power value “P₋” of the power spectrum of the negative frequency component. A power difference “P_{diff}” is shown by Equation (5).

$$\begin{matrix}[ Math . 5 ] & \\ {P}_{diff} = {P}_{+} - {P}_{-} & ( 5 )\end{matrix}$$

The offset estimation unit 506 estimates a frequency offset value of the received signal on the basis of the derived power difference (first power difference). For example, the offset estimation unit 506 estimates the frequency offset value of the received signal on the basis of a predetermined conversion equation and the derived power difference. For example, the offset estimation unit 506 may estimate the frequency offset value of the received signal on the basis of a predetermined data table and the derived power difference. In the data table, for example, the frequency offset value and the power difference are associated on the basis of a prior measurement result.

The received signal in the frequency domain is input to the compensation unit 507a (compensation circuit) from the fast Fourier transform unit 500. The estimated frequency offset value is input to the compensation unit 507a from the offset estimation unit 506. The compensation unit 507a compensates for frequency offset of the received signal on the basis of the estimated frequency offset value. The compensation unit 507a outputs the received signal for which the frequency offset has been compensated to the signal demodulation unit 508. The signal demodulation unit 508 performs predetermined demodulation processing on the received signal for which the frequency offset has been compensated. The signal demodulation unit 508 outputs the received signal subjected to the demodulation processing to the error correction decoding unit 533.

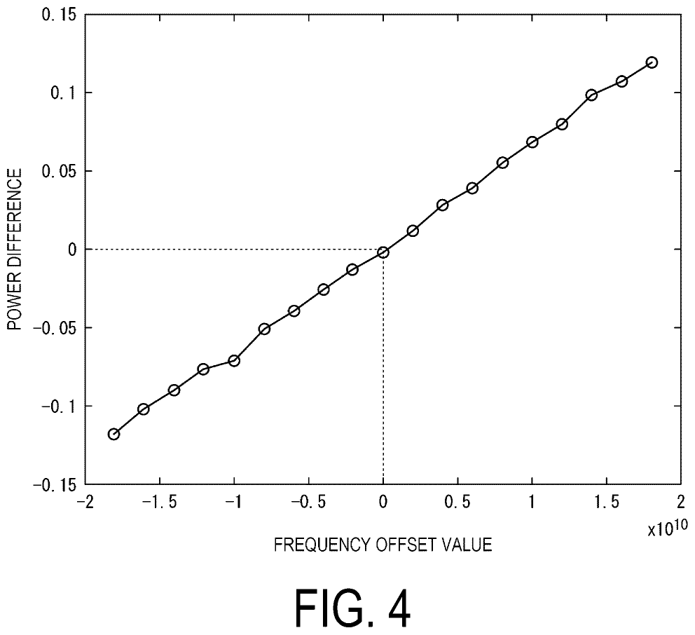

FIG. 4 shows an example of a relationship between the frequency offset value and the power difference in the first embodiment. Data showing the relationship between the frequency offset value and the power difference is stored in a predetermined storage unit of the demodulation unit 532a in the form of a data table, for example. In the data table, the power difference “0” and the frequency offset value “0” are associated with each other.

Next, an operation example of the reception device 5 will be described.

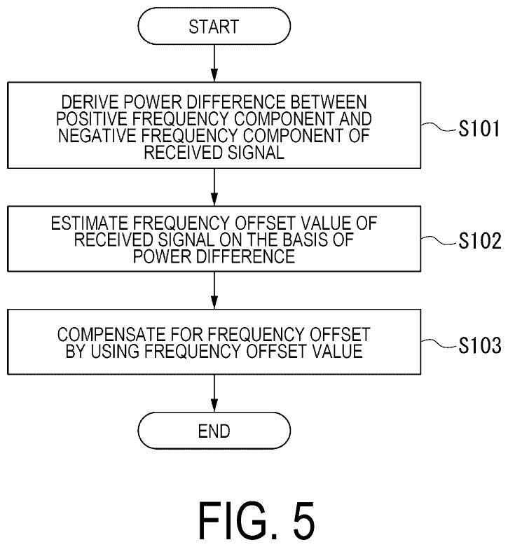

FIG. 5 is a flowchart showing the operation example of the reception device 5 in the first embodiment. The difference derivation unit 505 derives a power difference between a positive frequency component and a negative frequency component of a received signal (step S101). The offset estimation unit 506 estimates a frequency offset value of the received signal on the basis of the power difference between the positive frequency component and the negative frequency component (step S102). The compensation unit 507a compensates for frequency offset by using the estimated frequency offset value (step S103).

As described above, the difference derivation unit 505 derives the power difference (first power difference) between the positive frequency component and the negative frequency component of the received signal (electrical signal) converted from the received optical signal. The offset estimation unit 506 estimates the frequency offset value of the received signal on the basis of the first power difference. The compensation unit 507a compensates for the frequency offset of the received signal by using the frequency offset value.

This makes it possible to estimate wide frequency offset generated in a frequency of a received signal by using a reception device having a simple configuration. Even in a case where a small and inexpensive laser that tends to generate wide frequency offset is used for the configuration of the reception device, it is possible to achieve highly reliable optical communication.

### Second Embodiment

A second embodiment is different from the first embodiment mainly in that a compensation unit compensates for frequency offset of a received signal by adjusting a frequency of local oscillation light of a local oscillator. In the second embodiment, the difference from the first embodiment will be mainly described.

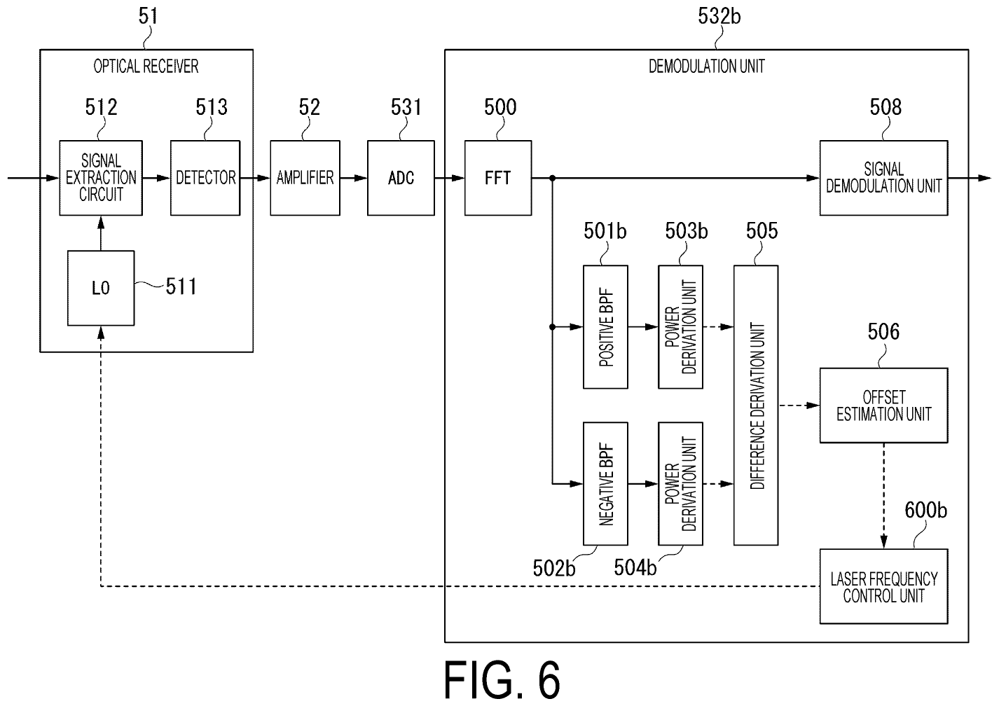

FIG. 6 shows a configuration example of a demodulation unit 532b in the second embodiment. The demodulation unit 532b includes a fast Fourier transform unit 500, a positive band-pass filter 501b, a negative band-pass filter 502b, a power derivation unit 503b, a power derivation unit 504b, a difference derivation unit 505, an offset estimation unit 506, a signal demodulation unit 508, and a laser frequency control unit 600b. The laser frequency control unit 600b may be mounted on, for example, a signal processing circuit inside the demodulation unit 532b or may be mounted on, for example, an FPGA (field programmable gate array) (not shown) outside the demodulation unit 532b.

In the second embodiment, a frequency offset value of a received signal is estimated by using each band-pass filter for positive and negative frequency components in a frequency domain. The laser frequency control unit 600b compensates for frequency offset of the received signal by adjusting a frequency of local oscillation light of the local oscillator 511.

The estimated frequency offset value is input to the laser frequency control unit 600b (compensation circuit) from the offset estimation unit 506. The laser frequency control unit 600b compensates for the frequency offset of the received signal on the basis of the estimated frequency offset value. The laser frequency control unit 600b adjusts the frequency of the local oscillation light of the local oscillator 511 on the basis of the estimated frequency offset value. Therefore, the fast Fourier transform unit 500 outputs the received signal for which the frequency offset has been compensated to the signal demodulation unit 508.

Note that the demodulation unit 532b may further include another compensation unit (not shown) different from the laser frequency control unit 600b at a subsequent stage of the fast Fourier transform unit 500. The another compensation unit (not shown) different from the laser frequency control unit 600b may perform highly accurate frequency offset compensation processing on the received signal output from the fast Fourier transform unit 500.

As described above, the difference derivation unit 505 derives the power difference (first power difference) between the positive frequency component and the negative frequency component of the received signal (electrical signal) converted from the received optical signal. The offset estimation unit 506 estimates the frequency offset value of the received signal on the basis of the first power difference. The laser frequency control unit 600b (compensation unit) compensates for the frequency offset of the received signal by adjusting (feeding back) the frequency of the local oscillation light of the local oscillator 511.

This makes it possible to estimate wide frequency offset generated in a frequency of a received signal by using a reception device having a simple configuration.

### Third Embodiment

A third embodiment is different from the first embodiment mainly in that a frequency offset value of a received signal is estimated by using band-pass filters in a time domain. In the third embodiment, the difference from the first embodiment will be mainly described.

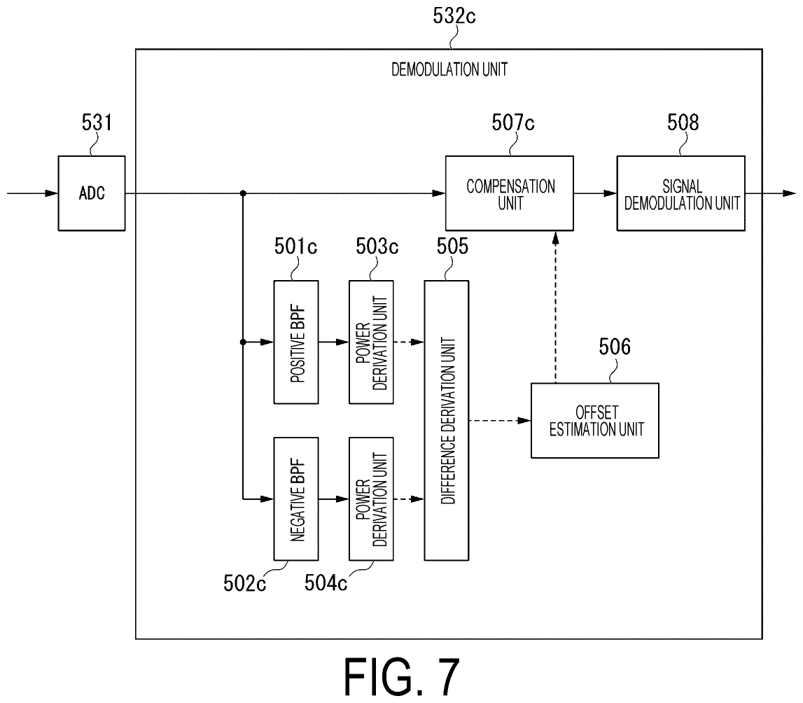

FIG. 7 shows a configuration example of a demodulation unit 532c in the third embodiment. The demodulation unit 532c includes a positive band-pass filter 501c, a negative band-pass filter 502c, a power derivation unit 503c, a power derivation unit 504c, a difference derivation unit 505, an offset estimation unit 506, a compensation unit 507c, and a signal demodulation unit 508.

In the third embodiment, a frequency offset value of a received signal is estimated by using each band-pass filter for positive and negative time components in a time domain. The compensation unit 507c performs processing of compensating for frequency offset of a received signal in a time domain (time series) on output of the analog-to-digital converter group 531.

The positive band-pass filter 501c extracts a positive time component from the received signal in the time domain (time series). The positive band-pass filter 501c outputs the extracted positive time component to the power derivation unit 503c. The negative band-pass filter 502c extracts a negative time component from the received signal in the time domain (time series). The negative band-pass filter 502c outputs the extracted negative time component to the power derivation unit 504c.

The power derivation unit 503c derives a power value of a power spectrum of the extracted positive time component. The power derivation unit 504c derives a power value of a power spectrum of the extracted negative time component. The difference derivation unit 505 derives a difference (power difference) between the power value “P₊” of the power spectrum of the positive time component and the power value “P₋” of the power spectrum of the negative time component. The offset estimation unit 506 estimates a frequency offset value of the received signal on the basis of the derived power difference (second power difference).

The received signal in the time domain (time series) is input to the compensation unit 507c (compensation circuit) from the analog-to-digital converter group 531. The estimated frequency offset value is input to the compensation unit 507c from the offset estimation unit 506. The compensation unit 507c compensates for frequency offset of the received signal on the basis of the estimated frequency offset value. The compensation unit 507c outputs the received signal for which the frequency offset has been compensated to the signal demodulation unit 508.

As described above, the difference derivation unit 505 derives the power difference (second power difference) between the positive time component and the negative time component of the received signal (electrical signal) converted from the received optical signal. The offset estimation unit 506 estimates the frequency offset value of the received signal on the basis of the second power difference. The compensation unit 507c compensates for the frequency offset of the received signal by using the frequency offset value.

This makes it possible to estimate wide frequency offset generated in a frequency of a received signal by using a reception device having a simple configuration.

### Fourth Embodiment

A fourth embodiment is different from the second embodiment mainly in that a frequency offset value of a received signal is estimated by using band-pass filters in a time domain. In the fourth embodiment, the difference from the second embodiment will be mainly described.

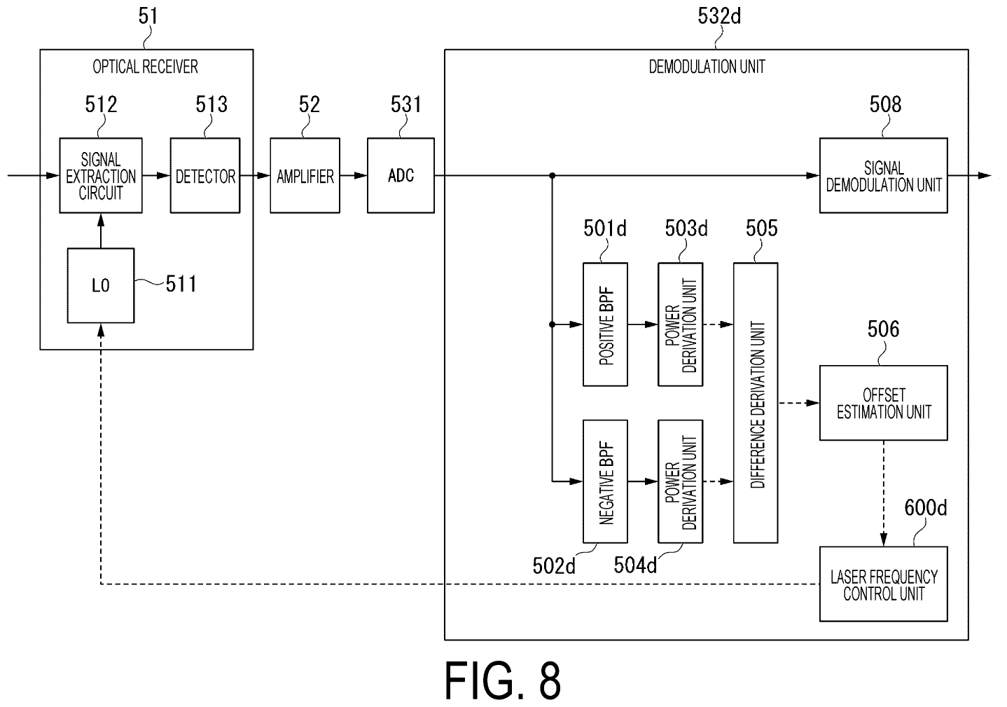

FIG. 8 shows a configuration example of a demodulation unit 532d in the fourth embodiment. The demodulation unit 532d includes a positive band-pass filter 501d, a negative band-pass filter 502d, a power derivation unit 503d, a power derivation unit 504d, a difference derivation unit 505, an offset estimation unit 506, a signal demodulation unit 508, and a laser frequency control unit 600d. The laser frequency control unit 600d may be mounted on, for example, a signal processing circuit inside the demodulation unit 532d or may be mounted on, for example, an FPGA (not shown) outside the demodulation unit 532d.

In the fourth embodiment, a frequency offset value of a received signal is estimated by using each band-pass filter for positive and negative time components in a time domain. The laser frequency control unit 600d compensates for frequency offset of the received signal by adjusting (feeding back) a frequency of local oscillation light of the local oscillator 511.

The positive band-pass filter 501d extracts a positive time component from the received signal in the time domain (time series). The positive band-pass filter 501d outputs the extracted positive time component to the power derivation unit 503d. The negative band-pass filter 502d extracts a negative time component from the received signal in the time domain (time series). The negative band-pass filter 502d outputs the extracted negative time component to the power derivation unit 504d.

The power derivation unit 503d derives a power value of a power spectrum of the extracted positive time component. The power derivation unit 504d derives a power value of a power spectrum of the extracted negative time component. The difference derivation unit 505 derives a difference (power difference) between the power value “P₊” of the power spectrum of the positive time component and the power value “P₋” of the power spectrum of the negative time component. The offset estimation unit 506 estimates a frequency offset value of the received signal on the basis of the derived power difference (second power difference). The laser frequency control unit 600d adjusts the frequency of the local oscillation light of the local oscillator 511 on the basis of the estimated frequency offset value. Therefore, the analog-to-digital converter group 531 outputs the received signal for which the frequency offset has been compensated to the signal demodulation unit 508.

Note that the demodulation unit 532d may further include another compensation unit (not shown) different from the laser frequency control unit 600d at a subsequent stage of the analog-to-digital converter group 531. The another compensation unit (not shown) different from the laser frequency control unit 600d may perform highly accurate frequency offset compensation processing on the received signal output from the analog-to-digital converter group 531.

As described above, the difference derivation unit 505 derives the power difference (second power difference) between the positive time component and the negative time component of the received signal (electrical signal) converted from the received optical signal. The offset estimation unit 506 estimates the frequency offset value of the received signal on the basis of the second power difference. The laser frequency control unit 600d (compensation unit) compensates for the frequency offset of the received signal by adjusting (feeding back) the frequency of the local oscillation light of the local oscillator 511.

This makes it possible to estimate wide frequency offset generated in a frequency of a received signal by using a reception device having a simple configuration.

### Fifth Embodiment

A fifth embodiment is different from the first embodiment mainly in that a frequency offset value of a received signal is estimated by using low-pass filters. In the fifth embodiment, the difference from the first embodiment will be mainly described.

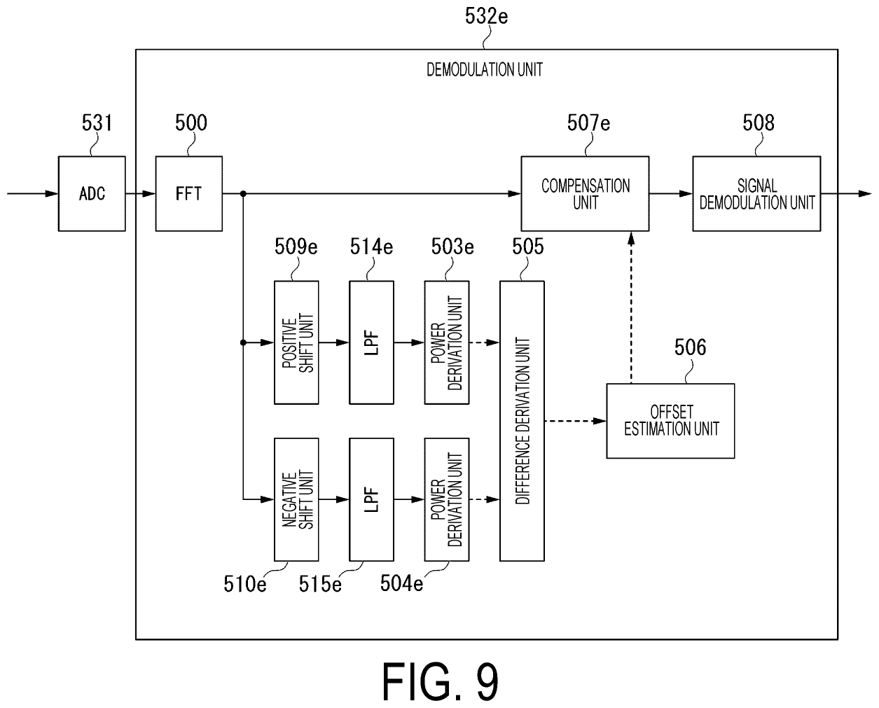

FIG. 9 shows a configuration example of a demodulation unit 532e in the fifth embodiment. The demodulation unit 532e includes a fast Fourier transform unit 500, a power derivation unit 503e, a power derivation unit 504e, a difference derivation unit 505, an offset estimation unit 506, a compensation unit 507e, a signal demodulation unit 508, a positive shift unit 509e, a negative shift unit 510e, a low-pass filter 514e, and a low-pass filter 515e.

In the fifth embodiment, a frequency offset value of a received signal is estimated by using low-pass filters for positive and negative frequency components, respectively, in a frequency domain. The compensation unit 507e performs processing of compensating for frequency offset of a received signal on output of the fast Fourier transform unit 500.

The positive shift unit 509e shifts the received signal in the frequency domain output from the fast Fourier transform unit 500 by a predetermined frequency in a positive direction or a negative direction. The predetermined frequency is determined in advance such that the low-pass filter 514e can extract a positive frequency component from the shifted received signal in the frequency domain.

The negative shift unit 510e shifts the received signal in the frequency domain output from the fast Fourier transform unit 500 by a predetermined frequency in the negative direction or the positive direction. The predetermined frequency is determined in advance such that the low-pass filter 515e can extract a negative frequency component from the shifted received signal in the frequency domain.

The low-pass filter 514e extracts a positive frequency component from the shifted received signal in the frequency domain. The low-pass filter 514e outputs the extracted positive frequency component to the power derivation unit 503e. The low-pass filter 515e extracts a negative frequency component from the shifted received signal in the frequency domain. The low-pass filter 515e outputs the extracted negative frequency component to the power derivation unit 504e.

The power derivation unit 503e derives a power value of a power spectrum of the extracted positive frequency component. The power derivation unit 504e derives a power value of a power spectrum of the extracted negative frequency component.

The difference derivation unit 505 derives a difference (power difference) between the power value “P₊” of the power spectrum of the positive frequency component and the power value “P₋” of the power spectrum of the negative frequency component.

The offset estimation unit 506 estimates the frequency offset value of the received signal on the basis of the derived power difference.

The compensation unit 507e compensates for frequency offset of the received signal on the basis of the estimated frequency offset value. The compensation unit 507e outputs the received signal for which the frequency offset has been compensated to the signal demodulation unit 508. The signal demodulation unit 508 performs predetermined demodulation processing on the received signal for which the frequency offset has been compensated. The signal demodulation unit 508 outputs the received signal subjected to the demodulation processing to the error correction decoding unit 533.

As described above, the frequency offset value of the received signal is estimated by using the low-pass filter 514e for the positive frequency component and the low-pass filter 515e for the negative frequency component in the frequency domain. The compensation unit 507e performs the processing of compensating for frequency offset of a received signal on the output of the fast Fourier transform unit 500.

This makes it possible to estimate wide frequency offset generated in a frequency of a received signal by using a reception device having a simple configuration.

### Sixth Embodiment

A sixth embodiment is different from the fifth embodiment mainly in that a compensation unit compensates for frequency offset of a received signal by adjusting a frequency of local oscillation light of a local oscillator. In the sixth embodiment, the difference from the fifth embodiment will be mainly described.

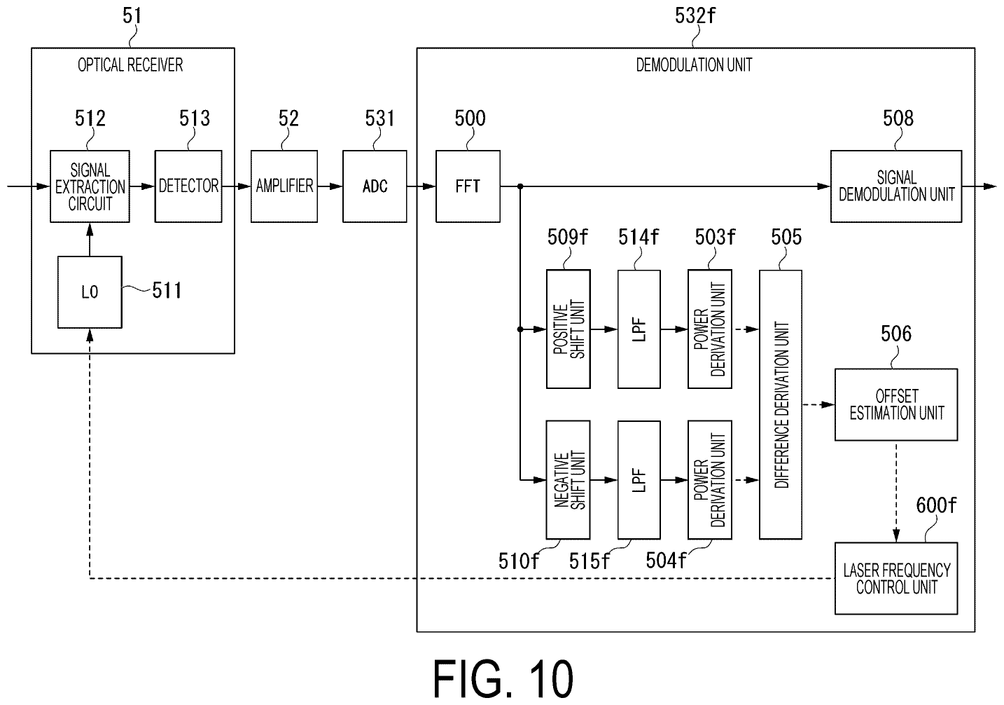

FIG. 10 shows a configuration example of a demodulation unit 532f in the sixth embodiment. The demodulation unit 532f includes a fast Fourier transform unit 500, a power derivation unit 503f, a power derivation unit 504f, a difference derivation unit 505, an offset estimation unit 506, a signal demodulation unit 508, a positive shift unit 509f, a negative shift unit 510f, a low-pass filter 514f, a low-pass filter 515f, and a laser frequency control unit 600f. The laser frequency control unit 600f may be mounted on, for example, a signal processing circuit inside the demodulation unit 532f or may be mounted on, for example, an FPGA (not shown) outside the demodulation unit 532f.

In the sixth embodiment, a frequency offset value of a received signal is estimated by using low-pass filters for positive and negative frequency components, respectively, in a frequency domain. The laser frequency control unit 600f compensates for frequency offset of the received signal by adjusting a frequency of local oscillation light of the local oscillator 511.

The estimated frequency offset value is input to the laser frequency control unit 600f (compensation circuit) from the offset estimation unit 506. The laser frequency control unit 600f compensates for the frequency offset of the received signal on the basis of the estimated frequency offset value. The laser frequency control unit 600f adjusts the frequency of the local oscillation light of the local oscillator 511 on the basis of the estimated frequency offset value. Therefore, the fast Fourier transform unit 500 outputs the received signal for which the frequency offset has been compensated to the signal demodulation unit 508.

Note that the demodulation unit 532f may further include another compensation unit (not shown) different from the laser frequency control unit 600f at a subsequent stage of the fast Fourier transform unit 500. The another compensation unit (not shown) different from the laser frequency control unit 600f may perform highly accurate frequency offset compensation processing on the received signal output from the fast Fourier transform unit 500.

As described above, the frequency offset value of the received signal is estimated by using the low-pass filter 514f for the positive frequency component and the low-pass filter 515f for the negative frequency component in the frequency domain. The laser frequency control unit 600f (compensation unit) compensates for the frequency offset of the received signal by adjusting the frequency of the local oscillation light of the local oscillator 511.

This makes it possible to estimate wide frequency offset generated in a frequency of a received signal by using a reception device having a simple configuration.

### Seventh Embodiment

A seventh embodiment is different from the fifth embodiment mainly in that a frequency offset value of a received signal is estimated by using low-pass filters in a time domain. In the seventh embodiment, the difference from the fifth embodiment will be mainly described.

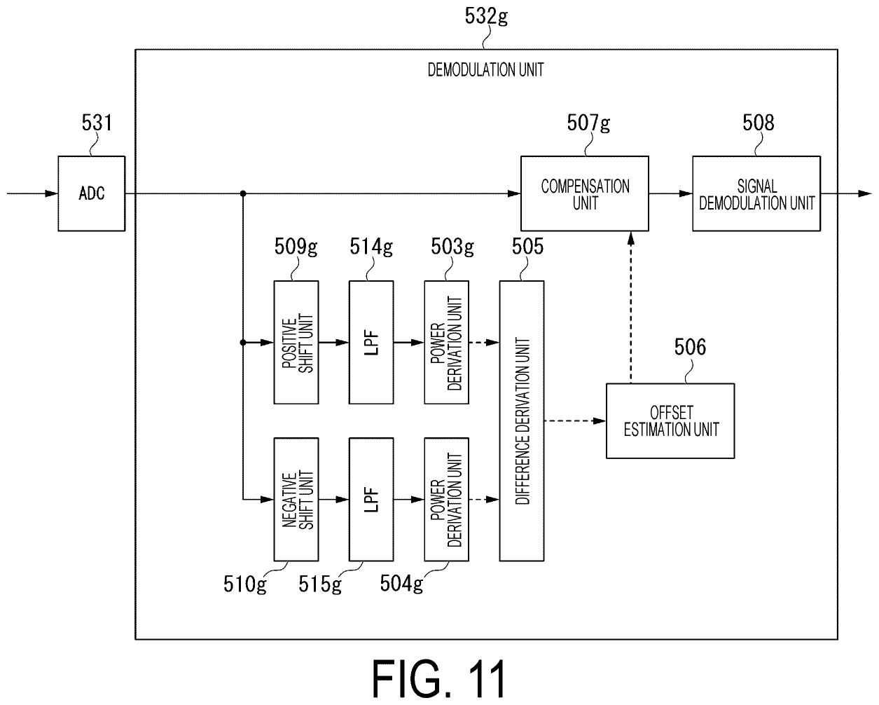

FIG. 11 shows a configuration example of a demodulation unit 532g in the seventh embodiment. The demodulation unit 532g includes a power derivation unit 503g, a power derivation unit 504g, a difference derivation unit 505, an offset estimation unit 506, a compensation unit 507g, a signal demodulation unit 508, a positive shift unit 509g, a negative shift unit 510g, a low-pass filter 514g, and a low-pass filter 515g.

In the seventh embodiment, a frequency offset value of a received signal is estimated by using low-pass filters for positive and negative time components, respectively, in a time domain. The compensation unit 507g performs processing of compensating for frequency offset of a received signal on output of the analog-to-digital converter group 531.

The positive shift unit 509g shifts the received signal in the time domain (time series) output from the analog-to-digital converter group 531 by a predetermined frequency in a positive direction or a negative direction. The predetermined frequency is determined in advance such that the low-pass filter 514g can extract a positive frequency component from the shifted received signal in the time domain.

The negative shift unit 510g shifts the received signal in the time domain (time series) output from the analog-to-digital converter group 531 by a predetermined frequency in the negative direction or the positive direction. The predetermined frequency is determined in advance such that the low-pass filter 515g can extract a negative frequency component from the shifted received signal in the time domain.

The low-pass filter 514g extracts a positive frequency component from the shifted received signal in the time domain. The low-pass filter 514g outputs the extracted positive frequency component to the power derivation unit 503g. The low-pass filter 515g extracts a negative frequency component from the shifted received signal in the time domain. The low-pass filter 515g outputs the extracted negative frequency component to the power derivation unit 504g.

The power derivation unit 503g derives a power value of a power spectrum of the extracted positive frequency component. The power derivation unit 504g derives a power value of a power spectrum of the extracted negative frequency component.

The difference derivation unit 505 derives a difference (power difference) between the power value “P₊” of the power spectrum of the positive frequency component and the power value “P₋” of the power spectrum of the negative frequency component. The offset estimation unit 506 estimates the frequency offset value of the received signal on the basis of the derived power difference.

The compensation unit 507g compensates for frequency offset of the received signal on the basis of the estimated frequency offset value. The compensation unit 507g outputs the received signal for which the frequency offset has been compensated to the signal demodulation unit 508. The signal demodulation unit 508 performs predetermined demodulation processing on the received signal for which the frequency offset has been compensated. The signal demodulation unit 508 outputs the received signal subjected to the demodulation processing to the error correction decoding unit 533.

As described above, the frequency offset value of the received signal is estimated by using the low-pass filter 514g for the positive time component and the low-pass filter 515g for the negative time component in the time domain. The compensation unit 507g performs the processing of compensating for frequency offset of a received signal on the output of the analog-to-digital converter group 531.

This makes it possible to estimate wide frequency offset generated in a frequency of a received signal by using a reception device having a simple configuration.

### Eighth Embodiment

An eighth embodiment is different from the sixth embodiment mainly in that a frequency offset value of a received signal is estimated by using low-pass filters in a time domain. In the eighth embodiment, the difference from the sixth embodiment will be mainly described.

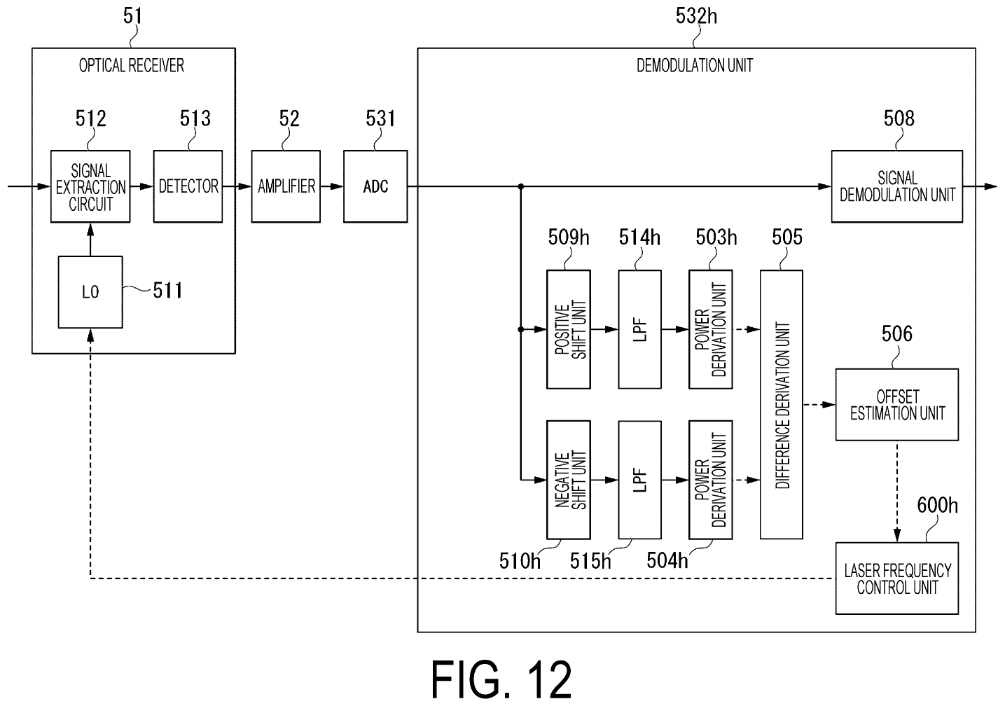

FIG. 12 shows a configuration example of a demodulation unit 532h in the eighth embodiment. The demodulation unit 532h includes a power derivation unit 503h, a power derivation unit 504h, a difference derivation unit 505, an offset estimation unit 506, a signal demodulation unit 508, a positive shift unit 509h, a negative shift unit 510h, a low-pass filter 514h, a low-pass filter 515h, and a laser frequency control unit 600h. The laser frequency control unit 600h may be mounted on, for example, a signal processing circuit inside the demodulation unit 532h or may be mounted on, for example, an FPGA (not shown) outside the demodulation unit 532h.

In the eighth embodiment, a frequency offset value of a received signal is estimated by using low-pass filters for positive and negative time components, respectively, in a time domain. The laser frequency control unit 600h compensates for frequency offset of the received signal by adjusting a frequency of local oscillation light of the local oscillator 511.

The positive shift unit 509h shifts the received signal in the time domain (time series) output from the analog-to-digital converter group 531 by a predetermined frequency in a positive direction or a negative direction. The predetermined frequency is determined in advance such that the low-pass filter 514h can extract a positive frequency component from the shifted received signal in the time domain.

The negative shift unit 510h shifts the received signal in the time domain (time series) output from the analog-to-digital converter group 531 by a predetermined frequency in the negative direction or the positive direction. The predetermined frequency is determined in advance such that the low-pass filter 515h can extract a negative frequency component from the shifted received signal in the time domain.

The low-pass filter 514h extracts a positive frequency component from the shifted received signal in the time domain. The low-pass filter 514h outputs the extracted positive frequency component to the power derivation unit 503h. The low-pass filter 515h extracts a negative frequency component from the shifted received signal in the time domain. The low-pass filter 515h outputs the extracted negative frequency component to the power derivation unit 504h.

The power derivation unit 503h derives a power value of a power spectrum of the extracted positive time component. The power derivation unit 504h derives a power value of a power spectrum of the extracted negative time component. The difference derivation unit 505 derives a difference (power difference) between the power value “P₊” of the power spectrum of the positive time component and the power value “P₋” of the power spectrum of the negative time component. The offset estimation unit 506 estimates the frequency offset value of the received signal on the basis of the derived power difference. The laser frequency control unit 600h adjusts the frequency of the local oscillation light of the local oscillator 511 on the basis of the estimated frequency offset value. Therefore, the analog-to-digital converter group 531 outputs the received signal for which the frequency offset has been compensated to the signal demodulation unit 508.

Note that the demodulation unit 532h may further include another compensation unit (not shown) different from the laser frequency control unit 600h at a subsequent stage of the analog-to-digital converter group 531. The another compensation unit (not shown) different from the laser frequency control unit 600h may perform highly accurate frequency offset compensation processing on the received signal output from the analog-to-digital converter group 531.

As described above, the frequency offset value of the received signal is estimated by using the low-pass filter 514h for the positive time component and the low-pass filter 515h for the negative time component in the time domain. The laser frequency control unit 600h (compensation unit) compensates for the frequency offset of the received signal by adjusting the frequency of the local oscillation light of the local oscillator 511.

This makes it possible to estimate wide frequency offset generated in a frequency of a received signal by using a reception device having a simple configuration.

### Ninth Embodiment

A ninth embodiment is different from the first embodiment mainly in that a positive frequency component and a negative frequency component are alternately acquired in a frequency domain. In the ninth embodiment, the difference from the first embodiment will be mainly described.

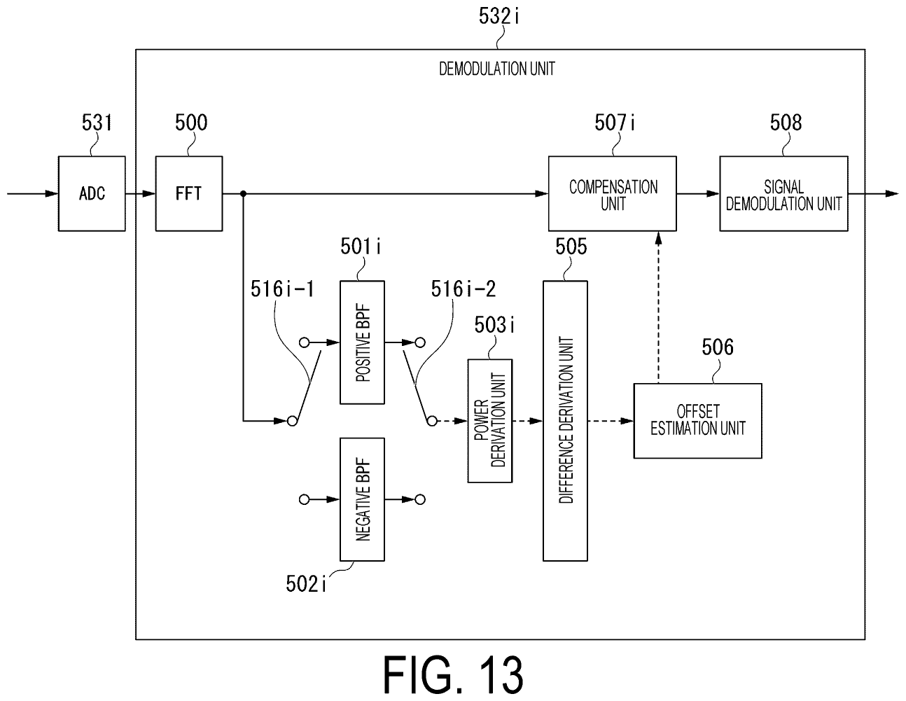

FIG. 13 shows a configuration example of a demodulation unit 532i in the ninth embodiment. The demodulation unit 532i includes a fast Fourier transform unit 500, a positive band-pass filter 501i, a negative band-pass filter 502i, a power derivation unit 503i, a difference derivation unit 505, an offset estimation unit 506, a compensation unit 507i, a signal demodulation unit 508, a switch 516i-1, and a switch 516i-2.

In the ninth embodiment, a frequency offset value of a received signal is estimated by alternately acquiring a positive frequency component and a negative frequency component in a frequency domain and using each band-pass filter for the positive and negative frequency components in the frequency domain. The compensation unit 507i performs processing of compensating for frequency offset of a received signal on output of the fast Fourier transform unit 500.

The switches 516i-1 and 516i-2 alternately input the received signal in the frequency domain output from the fast Fourier transform unit 500 to the positive band-pass filter 501i and the negative band-pass filter 502i.

The positive band-pass filter 501i extracts a positive frequency component from the received signal in the frequency domain. The positive band-pass filter 501i outputs the extracted positive frequency component to the power derivation unit 503i. The negative band-pass filter 502i extracts a negative frequency component from the received signal in the frequency domain. The negative band-pass filter 502i outputs the extracted negative frequency component to the power derivation unit 503i.

In a case where the extracted positive frequency component is input to the power derivation unit 503i, the power derivation unit 503i derives a power value of a power spectrum of the extracted positive frequency component. In a case where the extracted negative frequency component is input to the power derivation unit 503i, the power derivation unit 503i derives a power value of a power spectrum of the extracted negative frequency component.

The difference derivation unit 505 derives a difference (power difference) between the power value “P₊” of the power spectrum of the positive frequency component and the power value “P₋” of the power spectrum of the negative frequency component. The offset estimation unit 506 estimates the frequency offset value of the received signal on the basis of the derived power difference. The compensation unit 507i compensates for frequency offset of the received signal on the basis of the estimated frequency offset value. The compensation unit 507i outputs the received signal for which the frequency offset has been compensated to the signal demodulation unit 508.

As described above, the switch 516i alternately performs processing of outputting a frequency component to the positive band-pass filter 501i and processing of outputting a frequency component to the negative band-pass filter 502i. The frequency offset value of the received signal is estimated by using the positive band-pass filter 501i for the positive frequency component and the negative band-pass filter 502i for the negative frequency component in the frequency domain. The compensation unit 507i performs the processing of compensating for frequency offset of a received signal on the output of the fast Fourier transform unit 500.

This makes it possible to estimate wide frequency offset generated in a frequency of a received signal by using a reception device having a simple configuration.

### Tenth Embodiment

A tenth embodiment is different from the second embodiment mainly in that a positive frequency component and a negative frequency component are alternately acquired in a frequency domain. In the tenth embodiment, the difference from the second embodiment will be mainly described.

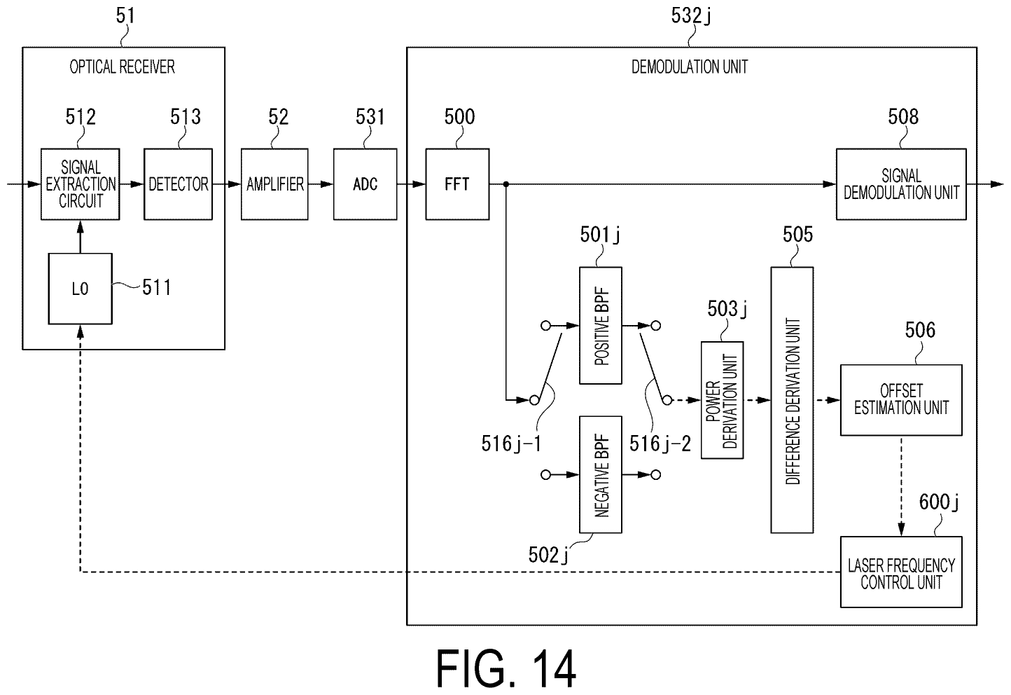

FIG. 14 shows a configuration example of a demodulation unit 532j in the tenth embodiment. The demodulation unit 532j includes a fast Fourier transform unit 500, a positive band-pass filter 501j, a negative band-pass filter 502j, a power derivation unit 503j, a difference derivation unit 505, an offset estimation unit 506, a signal demodulation unit 508, a switch 516j-1, a switch 516j-2, and a laser frequency control unit 600j. The laser frequency control unit 600j may be mounted on, for example, a signal processing circuit inside the demodulation unit 532j or may be mounted on, for example, an FPGA (not shown) outside the demodulation unit 532j.

In the tenth embodiment, a frequency offset value of a received signal is estimated by alternately acquiring a positive frequency component and a negative frequency component in a frequency domain and using each band-pass filter for the positive and negative frequency components in the frequency domain. The laser frequency control unit 600j compensates for frequency offset of the received signal by adjusting a frequency of local oscillation light of the local oscillator 511.

The estimated frequency offset value is input to the laser frequency control unit 600j (compensation circuit) from the offset estimation unit 506. The laser frequency control unit 600j compensates for the frequency offset of the received signal on the basis of the estimated frequency offset value. The laser frequency control unit 600j adjusts the frequency of the local oscillation light of the local oscillator 511 on the basis of the estimated frequency offset value. Therefore, the fast Fourier transform unit 500 outputs the received signal for which the frequency offset has been compensated to the signal demodulation unit 508.

Note that the demodulation unit 532j may further include another compensation unit (not shown) different from the laser frequency control unit 600j at a subsequent stage of the fast Fourier transform unit 500. The another compensation unit (not shown) different from the laser frequency control unit 600j may perform highly accurate frequency offset compensation processing on the received signal output from the fast Fourier transform unit 500.

As described above, the switch 516j alternately performs processing of outputting a frequency component to the positive band-pass filter 501j and processing of outputting a frequency component to the negative band-pass filter 502j. The frequency offset value of the received signal is estimated by using the positive band-pass filter 501j for the positive frequency component and the negative band-pass filter 502j for the negative frequency component in the frequency domain. The laser frequency control unit 600j (compensation unit) compensates for the frequency offset of the received signal by adjusting the frequency of the local oscillation light of the local oscillator 511.

This makes it possible to estimate wide frequency offset generated in a frequency of a received signal by using a reception device having a simple configuration.

### Eleventh Embodiment

An eleventh embodiment is different from the third embodiment mainly in that a positive time component and a negative time component are alternately acquired in a time domain. In the eleventh embodiment, the difference from the third embodiment will be mainly described.

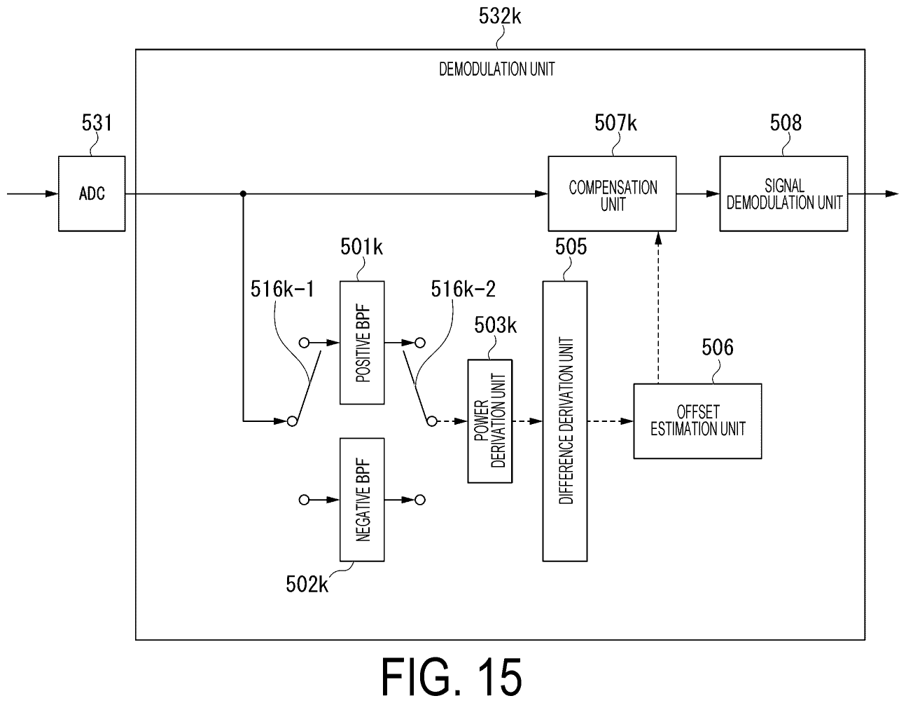

FIG. 15 shows a configuration example of a demodulation unit 532k in the eleventh embodiment. The demodulation unit 532k includes a positive band-pass filter 501k, a negative band-pass filter 502k, a power derivation unit 503k, a difference derivation unit 505, an offset estimation unit 506, a compensation unit 507k, a signal demodulation unit 508, a switch 516k-1, and a switch 516k-2.

In the eleventh embodiment, a frequency offset value of a received signal is estimated by alternately acquiring a positive time component and a negative time component in a time domain and using each band-pass filter for the positive and negative time components in the time domain. The compensation unit 507k performs processing of compensating for frequency offset of a received signal on output of the analog-to-digital converter group 531.

The switch 516k-1 and the switch 516k-2 alternately input the received signal in the time domain output from the analog-to-digital converter group 531 to the positive band-pass filter 501k and the negative band-pass filter 502k.

The positive band-pass filter 501k extracts a positive time component from the received signal in the time domain (time series). The positive band-pass filter 501k outputs the extracted positive time component to the power derivation unit 503k. The negative band-pass filter 502k extracts a negative time component from the received signal in the time domain (time series). The negative band-pass filter 502k outputs the extracted negative time component to the power derivation unit 503k.

The power derivation unit 503k derives a power value of a power spectrum of the extracted positive time component. The power derivation unit 503k derives a power value of a power spectrum of the extracted negative time component. The difference derivation unit 505 derives a difference (power difference) between the power value “P₊” of the power spectrum of the positive time component and the power value “P₋” of the power spectrum of the negative time component. The offset estimation unit 506 estimates the frequency offset value of the received signal on the basis of the derived power difference.

The received signal in the time domain (time series) is input to the compensation unit 507k (compensation circuit) from the analog-to-digital converter group 531. The estimated frequency offset value is input to the compensation unit 507k from the offset estimation unit 506. The compensation unit 507k compensates for frequency offset of the received signal on the basis of the estimated frequency offset value. The compensation unit 507k outputs the received signal for which the frequency offset has been compensated to the signal demodulation unit 508.

As described above, the switch 516k alternately performs processing of outputting a time component to the positive band-pass filter 501k and processing of outputting a time component to the negative band-pass filter 502k. The frequency offset value of the received signal is estimated by using the positive band-pass filter 501k for the positive time component and the negative band-pass filter 502k for the negative time component in the time domain. The compensation unit 507k performs the processing of compensating for frequency offset of a received signal on the output of the analog-to-digital converter group 531.

This makes it possible to estimate wide frequency offset generated in a frequency of a received signal by using a reception device having a simple configuration.

### Twelfth Embodiment

A twelfth embodiment is different from the fourth embodiment mainly in that a positive time component and a negative time component are alternately acquired in a time domain. In the twelfth embodiment, the difference from the fourth embodiment will be mainly described.

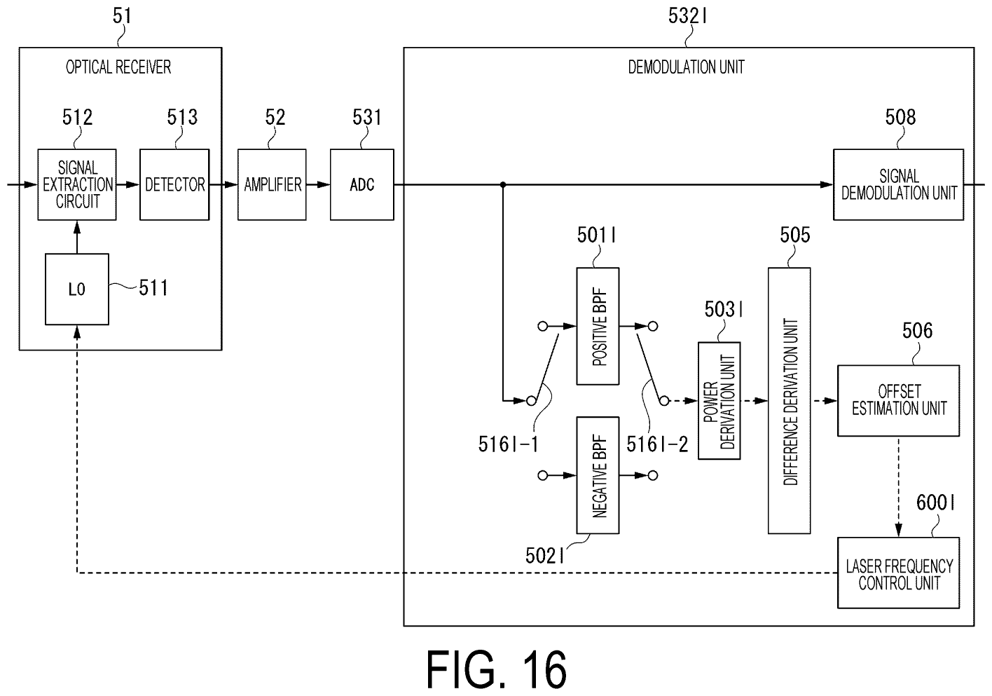

FIG. 16 shows a configuration example of a demodulation unit 532l in the twelfth embodiment. The demodulation unit 532l includes a positive band-pass filter 501l, a negative band-pass filter 502l, a power derivation unit 503l, a difference derivation unit 505, an offset estimation unit 506, a signal demodulation unit 508, a switch 516l-1, a switch 516l-2, and a laser frequency control unit 600l. The laser frequency control unit 600l may be mounted on, for example, a signal processing circuit inside the demodulation unit 532l or may be mounted on, for example, an FPGA (not shown) outside the demodulation unit 532l.

In the twelfth embodiment, a frequency offset value of a received signal is estimated by alternately acquiring a positive time component and a negative time component in a time domain and using each band-pass filter for the positive and negative time components in the time domain. The laser frequency control unit 600l compensates for frequency offset of the received signal by adjusting a frequency of local oscillation light of the local oscillator 511.

The switches 516l-1 and 516l-2 alternately input the received signal in the time domain output from the fast Fourier transform unit 500 to the positive band-pass filter 501l and the negative band-pass filter 502l.

The positive band-pass filter 501l extracts a positive time component from the received signal in the time domain (time series). The positive band-pass filter 501l outputs the extracted positive time component to the power derivation unit 503l. The negative band-pass filter 502l extracts a negative time component from the received signal in the time domain (time series). The negative band-pass filter 502l outputs the extracted negative time component to the power derivation unit 503l.

The power derivation unit 503l derives a power value of a power spectrum of the extracted positive time component. The power derivation unit 503l derives a power value of a power spectrum of the extracted negative time component. The difference derivation unit 505 derives a difference (power difference) between the power value “P₊” of the power spectrum of the positive time component and the power value “P₋” of the power spectrum of the negative time component. The offset estimation unit 506 estimates the frequency offset value of the received signal on the basis of the derived power difference. The laser frequency control unit 600l adjusts the frequency of the local oscillation light of the local oscillator 511 on the basis of the estimated frequency offset value. Therefore, the analog-to-digital converter group 531 outputs the received signal for which the frequency offset has been compensated to the signal demodulation unit 508.

Note that the demodulation unit 532l may further include another compensation unit (not shown) different from the laser frequency control unit 600l at a subsequent stage of the analog-to-digital converter group 531. The another compensation unit (not shown) different from the laser frequency control unit 600l may perform highly accurate frequency offset compensation processing on the received signal output from the analog-to-digital converter group 531.

As described above, the switch 516l alternately performs processing of outputting a time component to the positive band-pass filter 501l and processing of outputting a time component to the negative band-pass filter 502l. The frequency offset value of the received signal is estimated by using the positive band-pass filter 501l for the positive time component and the negative band-pass filter 502l for the negative time component. The laser frequency control unit 600l (compensation unit) compensates for the frequency offset of the received signal by adjusting the frequency of the local oscillation light of the local oscillator 511.

This makes it possible to estimate wide frequency offset generated in a frequency of a received signal by using a reception device having a simple configuration.

### Thirteenth Embodiment

A thirteenth embodiment is different from the fifth embodiment mainly in that a positive frequency component and a negative frequency component are alternately acquired in a frequency domain. In the thirteenth embodiment, the difference from the fifth embodiment will be mainly described.

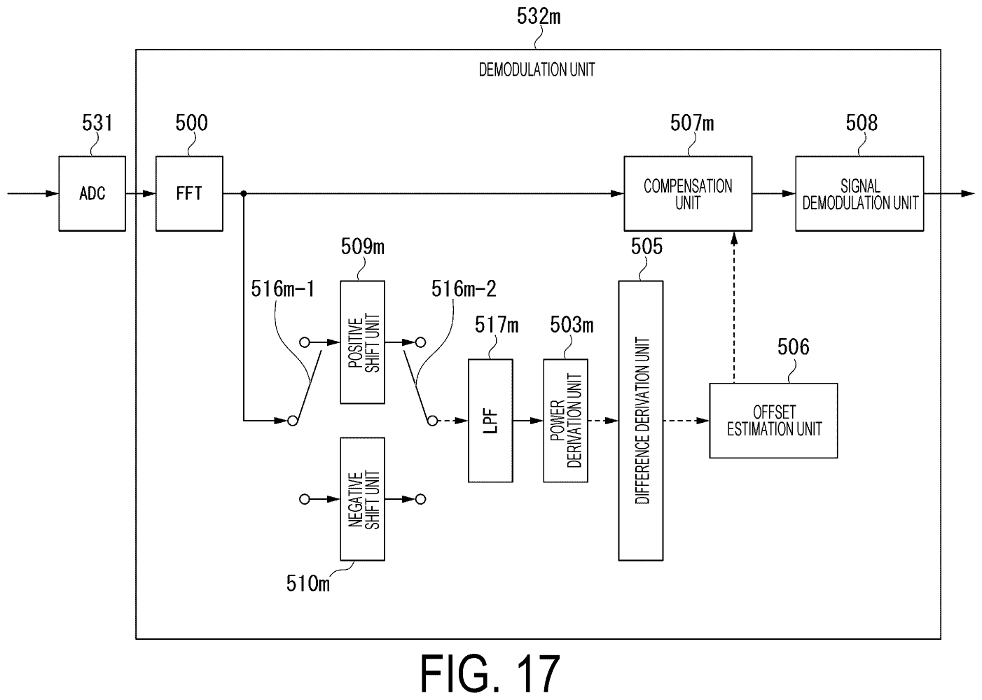

FIG. 17 shows a configuration example of a demodulation unit 532m in the thirteenth embodiment. The demodulation unit 532m includes a fast Fourier transform unit 500, a power derivation unit 503m, a power derivation unit 504m, a difference derivation unit 505, an offset estimation unit 506, a compensation unit 507m, a signal demodulation unit 508, a positive shift unit 509m, a negative shift unit 510m, a low-pass filter 514m, a low-pass filter 515m, a switch 516m-1, and a switch 516m-2.

In the thirteenth embodiment, a frequency offset value of a received signal is estimated by alternately acquiring a positive frequency component and a negative frequency component in a frequency domain and using a low-pass filter for the positive and negative frequency components in the frequency domain. The compensation unit 507m performs processing of compensating for frequency offset of a received signal on output of the fast Fourier transform unit 500.

The switches 516m-1 and 516m-2 alternately input the received signal in the frequency domain output from the fast Fourier transform unit 500 to the positive shift unit 509m and the negative shift unit 510m.

The positive shift unit 509m shifts the received signal in the frequency domain output from the fast Fourier transform unit 500 by a predetermined frequency in a positive direction or negative direction. The predetermined frequency is determined in advance such that the low-pass filter 514m can extract a positive frequency component from the shifted received signal in the frequency domain.

The negative shift unit 510m shifts the received signal in the frequency domain output from the fast Fourier transform unit 500 by a predetermined frequency in the negative direction or the positive direction. The predetermined frequency is determined in advance such that the low-pass filter 515m can extract a negative frequency component from the shifted received signal in the frequency domain.

The low-pass filter 514m extracts a positive frequency component from the shifted received signal in the frequency domain. The low-pass filter 514m outputs the extracted positive frequency component to the power derivation unit 503m. The low-pass filter 515m extracts a negative frequency component from the shifted received signal in the frequency domain. The low-pass filter 515m outputs the extracted negative frequency component to the power derivation unit 504m.

The power derivation unit 503m derives a power value of a power spectrum of the extracted positive frequency component. The power derivation unit 504m derives a power value of a power spectrum of the extracted negative frequency component.

The difference derivation unit 505 derives a difference (power difference) between the power value “P₊” of the power spectrum of the positive frequency component and the power value “P₋” of the power spectrum of the negative frequency component. The offset estimation unit 506 estimates the frequency offset value of the received signal on the basis of the derived power difference.

The compensation unit 507m compensates for frequency offset of the received signal on the basis of the estimated frequency offset value. The compensation unit 507m outputs the received signal for which the frequency offset has been compensated to the signal demodulation unit 508. The signal demodulation unit 508 performs predetermined demodulation processing on the received signal for which the frequency offset has been compensated. The signal demodulation unit 508 outputs the received signal subjected to the demodulation processing to the error correction decoding unit 533.

As described above, the switch 516m alternately performs processing of outputting a frequency component to the positive shift unit 509m and processing of outputting a frequency component to the negative shift unit 510m. The frequency offset value of the received signal is estimated by using the low-pass filter 517m for the positive and negative frequency components in the frequency domain. The compensation unit 507m performs the processing of compensating for frequency offset of a received signal on the output of the fast Fourier transform unit 500.

This makes it possible to estimate wide frequency offset generated in a frequency of a received signal by using a reception device having a simple configuration.

### Fourteenth Embodiment

A fourteenth embodiment is different from the sixth embodiment mainly in that a positive frequency component and a negative frequency component are alternately acquired in a frequency domain. In the fourteenth embodiment, the difference from the sixth embodiment will be mainly described.

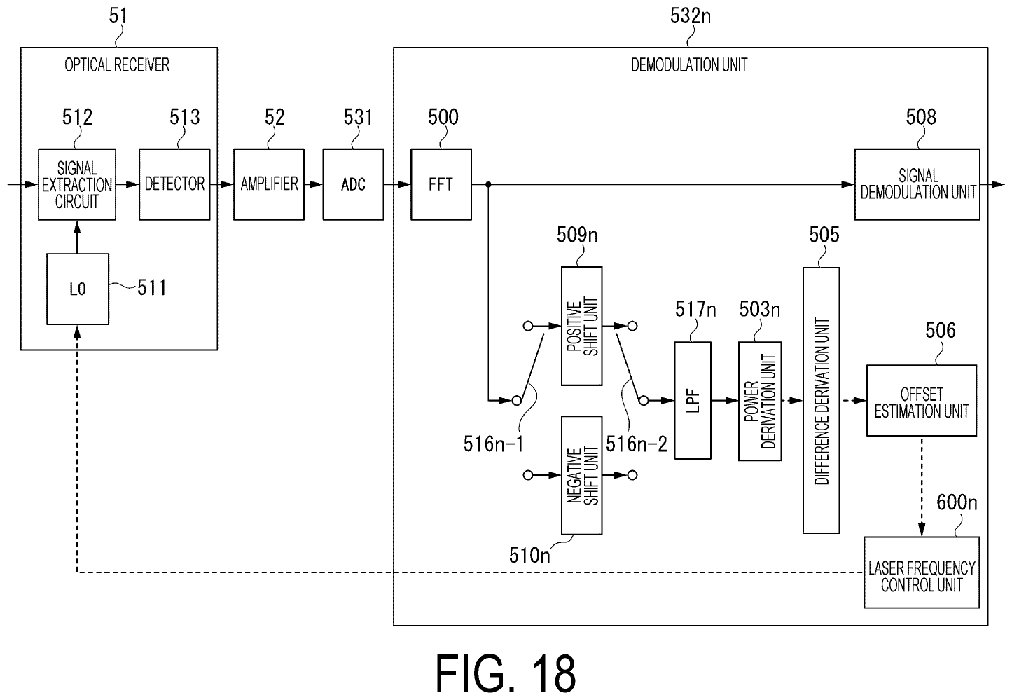

FIG. 18 shows a configuration example of a demodulation unit 532n in the fourteenth embodiment. The demodulation unit 532n includes a fast Fourier transform unit 500, a power derivation unit 503n, a power derivation unit 504n, a difference derivation unit 505, an offset estimation unit 506, a signal demodulation unit 508, a positive shift unit 509n, a negative shift unit 510n, a switch 516n-1, a switch 516n-2, a low-pass filter 514n, a low-pass filter 515n, and a laser frequency control unit 600n. The laser frequency control unit 600n may be mounted on, for example, a signal processing circuit inside the demodulation unit 532n or may be mounted on, for example, an FPGA (not shown) outside the demodulation unit 532n.

In the fourteenth embodiment, a frequency offset value of a received signal is estimated by alternately acquiring a positive frequency component and a negative frequency component in a frequency domain and using a low-pass filter for the positive and negative frequency components in the frequency domain. The laser frequency control unit 600n compensates for frequency offset of the received signal by adjusting a frequency of local oscillation light of the local oscillator 511.

The switches 516n-1 and 516n-2 alternately input the received signal in the frequency domain output from the fast Fourier transform unit 500 to the positive shift unit 509n and the negative shift unit 510n.

The estimated frequency offset value is input to the laser frequency control unit 600n (compensation circuit) from the offset estimation unit 506. The laser frequency control unit 600n compensates for frequency offset of the received signal on the basis of the estimated frequency offset value. The laser frequency control unit 600n adjusts the frequency of the local oscillation light of the local oscillator 511 on the basis of the estimated frequency offset value. Therefore, the fast Fourier transform unit 500 outputs the received signal for which the frequency offset has been compensated to the signal demodulation unit 508.

Note that the demodulation unit 532n may further include another compensation unit (not shown) different from the laser frequency control unit 600n at a subsequent stage of the fast Fourier transform unit 500. The another compensation unit (not shown) different from the laser frequency control unit 600n may perform highly accurate frequency offset compensation processing on the received signal output from the fast Fourier transform unit 500.

As described above, the switch 516n alternately performs processing of outputting a frequency component to the positive shift unit 509n and processing of outputting a frequency component to the negative shift unit 510n. The frequency offset value of the received signal is estimated by using the low-pass filter 517n for the positive and negative frequency components in the frequency domain. The laser frequency control unit 600n (compensation unit) compensates for the frequency offset of the received signal by adjusting the frequency of the local oscillation light of the local oscillator 511.

This makes it possible to estimate wide frequency offset generated in a frequency of a received signal by using a reception device having a simple configuration.

### Fifteenth Embodiment

A fifteenth embodiment is different from the seventh embodiment mainly in that a positive time component and a negative time component are alternately acquired in a time domain. In the fifteenth embodiment, the difference from the seventh embodiment will be mainly described.

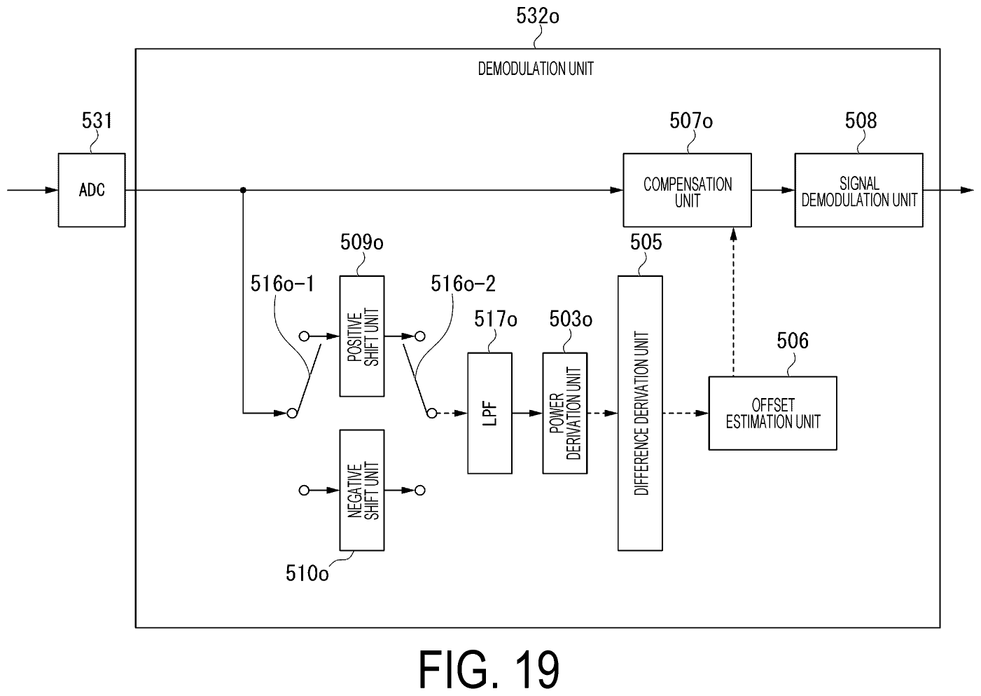

FIG. 19 shows a configuration example of a demodulation unit 532o in the fifteenth embodiment. The demodulation unit 532o includes a power derivation unit 503o, a power derivation unit 504o, a difference derivation unit 505, an offset estimation unit 506, a compensation unit 507o, a signal demodulation unit 508, a positive shift unit 509o, a negative shift unit 510o, a low-pass filter 514o, a low-pass filter 515o, a switch 516o-1, and a switch 516o-2.

In the fifteenth embodiment, a frequency offset value of a received signal is estimated by alternately acquiring a positive time component and a negative time component in a time domain and using a low-pass filter for the positive and negative time components in the time domain. The compensation unit 507o performs processing of compensating for frequency offset of a received signal on output of the analog-to-digital converter group 531.

The switches 516o-1 and 516o-2 alternately input the received signal in the time domain output from the analog-to-digital converter group 531 to the positive shift unit 509o and the negative shift unit 510o.

The positive shift unit 509o shifts the received signal in the time domain (time series) output from the analog-to-digital converter group 531 by a predetermined frequency in a positive direction or a negative direction. The predetermined frequency is determined in advance such that the low-pass filter 514o can extract a positive frequency component from the shifted received signal in the time domain.

The negative shift unit 510o shifts the received signal in the time domain (time series) output from the analog-to-digital converter group 531 by a predetermined frequency in the negative direction or the positive direction. The predetermined frequency is determined in advance such that the low-pass filter 515o can extract a negative frequency component from the shifted received signal in the time domain.

The low-pass filter 514o extracts a positive frequency component from the shifted received signal in the time domain. The low-pass filter 514o outputs the extracted positive frequency component to the power derivation unit 503o. The low-pass filter 515o extracts a negative frequency component from the shifted received signal in the time domain. The low-pass filter 515o outputs the extracted negative frequency component to the power derivation unit 504o.

The power derivation unit 503o derives a power value of a power spectrum of the extracted positive frequency component. The power derivation unit 504o derives a power value of a power spectrum of the extracted negative frequency component.

The difference derivation unit 505 derives a difference (power difference) between the power value “P₊” of the power spectrum of the positive frequency component and the power value “P₋” of the power spectrum of the negative frequency component. The offset estimation unit 506 estimates the frequency offset value of the received signal on the basis of the derived power difference.

The compensation unit 507o compensates for frequency offset of the received signal on the basis of the estimated frequency offset value. The compensation unit 507o outputs the received signal for which the frequency offset has been compensated to the signal demodulation unit 508. The signal demodulation unit 508 performs predetermined demodulation processing on the received signal for which the frequency offset has been compensated. The signal demodulation unit 508 outputs the received signal subjected to the demodulation processing to the error correction decoding unit 533.

As described above, the switches 516o alternately perform processing of outputting a time component to the positive shift unit 509o and processing of outputting a time component to the negative shift unit 510o. The frequency offset value of the received signal is estimated by using the low-pass filter 517o for the positive and negative time components in the time domain. The compensation unit 507o performs the processing of compensating for frequency offset of a received signal on the output of the analog-to-digital converter group 531.

This makes it possible to estimate wide frequency offset generated in a frequency of a received signal by using a reception device having a simple configuration.

### Sixteenth Embodiment

A sixteenth embodiment is different from the eighth embodiment mainly in that a positive time component and a negative time component are alternately acquired in a time domain. In the sixteenth embodiment, the difference from the eighth embodiment will be mainly described.

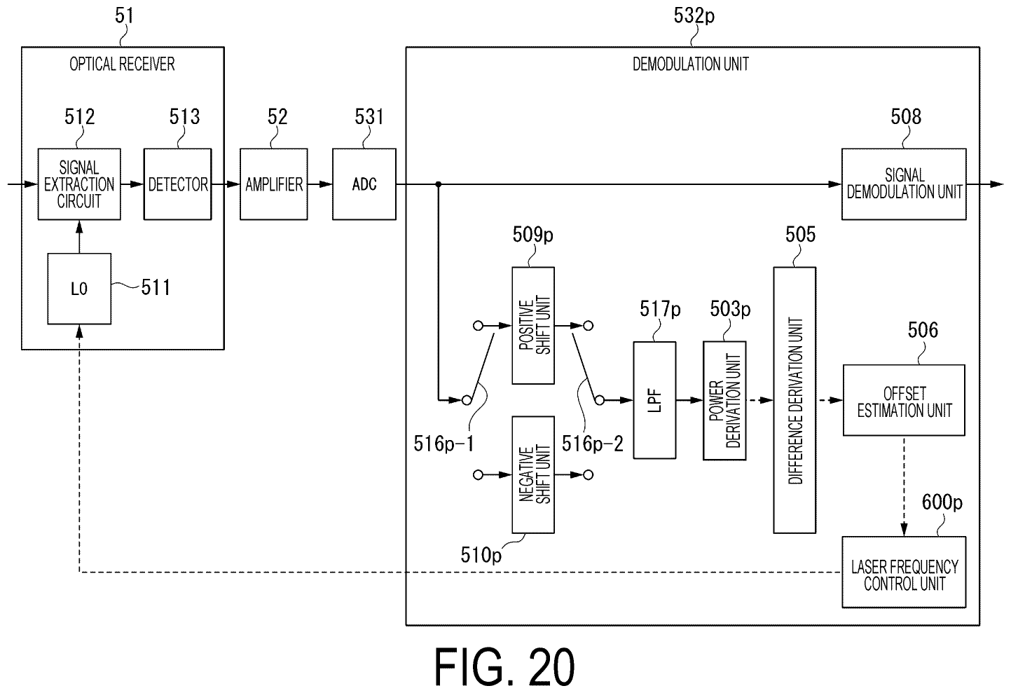

FIG. 20 shows a configuration example of a demodulation unit 532p in the sixteenth embodiment. The demodulation unit 532p includes a power derivation unit 503p, a power derivation unit 504p, a difference derivation unit 505, an offset estimation unit 506, a signal demodulation unit 508, a positive shift unit 509p, a negative shift unit 510p, a low-pass filter 514p, a low-pass filter 515p, a switch 516p-1, a switch 516p-2, and a laser frequency control unit 600p. The laser frequency control unit 600p may be mounted on, for example, a signal processing circuit inside the demodulation unit 532p or may be mounted on, for example, an FPGA (not shown) outside the demodulation unit 532p.

In the sixteenth embodiment, a frequency offset value of a received signal is estimated by alternately acquiring a positive time component and a negative time component in a time domain and using a low-pass filter for the positive and negative time components in the time domain. The laser frequency control unit 600p compensates for frequency offset of the received signal by adjusting a frequency of local oscillation light of the local oscillator 511.

The switches 516p-1 and 516p-2 alternately input the received signal in the time domain output from the analog-to-digital converter group 531 to the positive shift unit 509p and the negative shift unit 510p.

The positive shift unit 509p shifts the received signal in the time domain (time series) output from the analog-to-digital converter group 531 by a predetermined frequency in a positive direction or a negative direction. The predetermined frequency is determined in advance such that the low-pass filter 514p can extract a positive frequency component from the shifted received signal in the time domain.

The negative shift unit 510p shifts the received signal in the time domain (time series) output from the analog-to-digital converter group 531 by a predetermined frequency in the negative direction or the positive direction. The predetermined frequency is determined in advance such that the low-pass filter 515p can extract a negative frequency component from the shifted received signal in the time domain.

The low-pass filter 514p extracts a positive frequency component from the shifted received signal in the time domain. The low-pass filter 514p outputs the extracted positive frequency component to the power derivation unit 503p. The low-pass filter 515p extracts a negative frequency component from the shifted received signal in the time domain. The low-pass filter 515p outputs the extracted negative frequency component to the power derivation unit 504p.

The power derivation unit 503p derives a power value of a power spectrum of the extracted positive time component. The power derivation unit 504p derives a power value of a power spectrum of the extracted negative time component. The difference derivation unit 505 derives a difference (power difference) between the power value “P₊” of the power spectrum of the positive time component and the power value “P₋” of the power spectrum of the negative time component. The offset estimation unit 506 estimates the frequency offset value of the received signal on the basis of the derived power difference. The laser frequency control unit 600p adjusts the frequency of the local oscillation light of the local oscillator 511 on the basis of the estimated frequency offset value. Therefore, the analog-to-digital converter group 531 outputs the received signal for which the frequency offset has been compensated to the signal demodulation unit 508.

Note that the demodulation unit 532p may further include another compensation unit (not shown) different from the laser frequency control unit 600p at a subsequent stage of the analog-to-digital converter group 531. The another compensation unit (not shown) different from the laser frequency control unit 600p may perform highly accurate frequency offset compensation processing on the received signal output from the analog-to-digital converter group 531.

As described above, the switch 516p alternately perform processing of outputting a time component to the positive shift unit 509p and processing of outputting a time component to the negative shift unit 510p. The frequency offset value of the received signal is estimated by using the low-pass filter 517p for the positive and negative time components in the time domain. The laser frequency control unit 600p (compensation unit) compensates for the frequency offset of the received signal by adjusting the frequency of the local oscillation light of the local oscillator 511.

This makes it possible to estimate wide frequency offset generated in a frequency of a received signal by using a reception device having a simple configuration.

### Seventeenth Embodiment

A seventeenth embodiment is different from the first to sixteenth embodiments mainly in that frequency offset compensation processing is performed in a divided manner. In the seventeenth embodiment, the difference from the first to sixteenth embodiments will be mainly described.

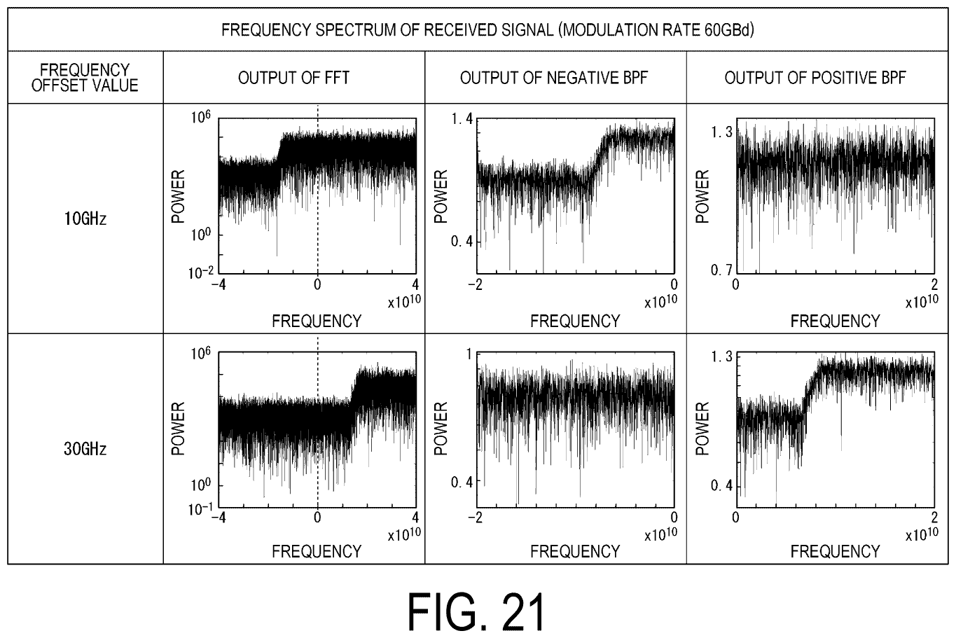

FIG. 21 shows an example of frequency spectra (power spectra) of a received signal in the seventeenth embodiment. A modulation rate of the received signal in FIG. 21 is, for example, 60 GBd. In a case where a frequency offset value is other than “0 GHz”, a power spectrum of a positive frequency component and a power spectrum of a negative frequency component are substantially asymmetrical with respect to a frequency “0 GHz”.

Here, the power spectrum of the positive frequency component in a case where the frequency offset value is, for example, 10 GHz is different from the power spectrum of the positive frequency component in a case where the frequency offset value is, for example, 30 GHz. Similarly, the power spectrum of the negative frequency component in a case where the frequency offset value is, for example, 10 GHz is different from the power spectrum of the negative frequency component in a case where the frequency offset value is, for example, 30 GHz.

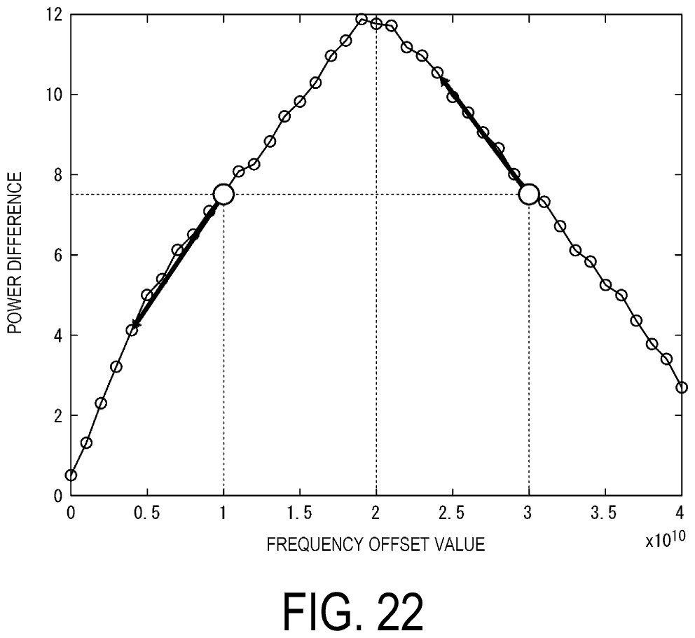

FIG. 22 shows an example of a peak of a power difference in the seventeenth embodiment. The power difference may decrease in a case where an estimated value of the frequency offset value exceeds a certain value. In FIG. 22, for example, the power difference decreases in a case where the estimated value of the frequency offset value exceeds “2.0×10¹⁰”.

In a case where the entire power spectrum of one of the positive and negative frequency components deviates from a band of the band-pass filter or the low-pass filter, power of the deviating frequency component is zero, and thus the power difference becomes a peak. Therefore, even if the power differences have the same value, the estimated values of the frequency offset values may be different on both sides of the peak of the power difference.

In a frequency offset value region where the power difference decreases as the frequency offset value increases, the entire power spectrum of one of the positive and negative frequency components deviates from the band of the band-pass filter or the low-pass filter. Meanwhile, in a frequency offset value region where the power difference decreases as the frequency offset value increases, a part of the power spectrum of another one of the positive and negative frequency components deviates from the band of the band-pass filter or the low-pass filter.

In a case where there is no possibility that the frequency offset value of the received signal is larger than the frequency offset value associated with the peak of the power difference, the compensation unit can collectively compensate for the frequency offset on the basis of the estimated value of the frequency offset value. For example, in a case where a specification of laser light defines that a frequency offset value of the laser light does not exceed the frequency offset value associated with the peak of the power difference, the compensation unit can collectively compensate for the frequency offset on the basis of the estimated value of the frequency offset value. In FIG. 22, in a case where the specification of the laser light defines that the frequency offset of the laser is equal to or less than “2.0×10¹⁰”, the frequency offset value is determined not to be “3.0×10¹⁰” among potential frequency offset values, but to be “1.0×10¹⁰” among the potential frequency offset values. Therefore, the compensation unit can collectively compensate for the frequency offset on the basis of the estimated value “1.0×10¹⁰” of the frequency offset value.

In a case where there is a possibility that the frequency offset value of the received signal is larger than the frequency offset value associated with the peak of the power difference, the estimation processing and compensation processing of the frequency offset value are performed a plurality of times in a divided manner. Here, in a case where the frequency offset value of the received signal is smaller than the frequency offset value associated with the peak of the power difference, the power difference decreases when a part of the frequency offset is compensated for. Meanwhile, in a case where the frequency offset value of the received signal is larger than the frequency offset value associated with the peak of the power difference, the power difference increases when a part of the frequency offset is compensated for. Therefore, the offset estimation unit 506 determines whether or not the frequency offset value of the received signal is larger than the frequency offset value associated with the peak of the power difference on the basis of results of the estimation processing and the compensation processing performed the plurality of times in a divided manner.

In FIG. 22, in a case where the derived power difference is, for example, “7.5”, potential frequency offset values are “1.0×10¹⁰” and “3.0×10¹⁰”. The compensation unit compensates for the frequency offset by, for example, 6 GHz. That is, the compensation unit decreases the frequency offset value by, for example, “0.6×10¹⁰”.

In a case where the power difference decreases when a part of the frequency offset is compensated for, the offset estimation unit 506 determines that the frequency offset value of the received signal is smaller than the frequency offset value associated with the peak of the power difference. Based on the determination result, the offset estimation unit 506 selects a smaller potential frequency offset value “1.0×10¹⁰” between the potential frequency offset values. The compensation unit compensates for the frequency offset of the received signal on the basis of the selected frequency offset value “1.0×10¹⁰”.

In a case where the power difference increases when a part of the frequency offset is compensated for, the offset estimation unit 506 determines that the frequency offset value of the received signal is larger than the frequency offset value associated with the peak of the power difference. Based on the determination result, the offset estimation unit 506 selects a larger potential frequency offset value “3.0×10¹⁰” between the potential frequency offset values. The compensation unit compensates for the frequency offset of the received signal on the basis of the selected frequency offset value “3.0×10¹⁰”.

Next, an operation example of the reception device 5 will be described.

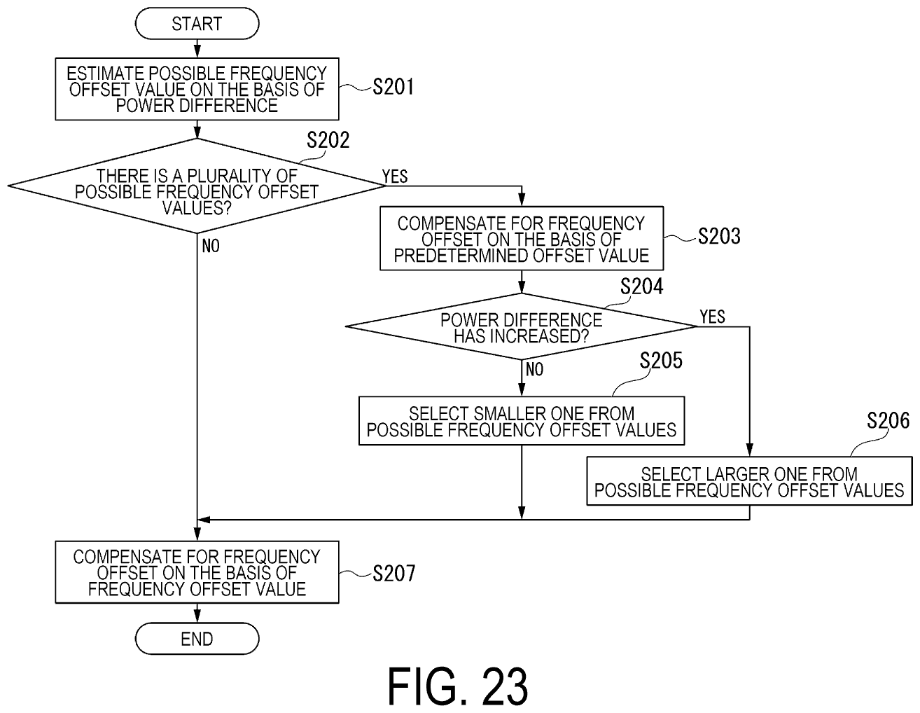

FIG. 23 is a flowchart showing the operation example of the reception device 5 in the seventeenth embodiment. The reception device 5 in the seventeenth embodiment may correspond to any reception device 5 in the first to sixteenth embodiments.

The offset estimation unit 506 estimates a potential frequency offset value on the basis of a power difference. For example, in FIG. 22, the offset estimation unit 506 estimates potential frequency offset values “1.0×10¹⁰” and “3.0×10¹⁰” associated with a power difference “7.5” (step S201). The offset estimation unit 506 determines whether or not there is a plurality of potential frequency offset values (step S202).

When it is determined that there is a plurality of potential frequency offset values (step S202: YES), the compensation unit of the demodulation unit compensates for frequency offset on the basis of a predetermined small offset value (e.g. 6 GHz) (step S203). The difference derivation unit 505 derives a power difference of a received signal. The offset estimation unit 506 determines whether or not the power difference has increased (step S204).

When it is determined that the power difference has decreased (step S204: NO), the offset estimation unit 506 selects a smaller frequency offset value from the potential frequency offset values. For example, in FIG. 22, the offset estimation unit 506 selects the potential frequency offset value “1.0×10¹⁰” (step S205).

When it is determined that the power difference has increased (step S204: YES), the offset estimation unit 506 selects a larger frequency offset value from the potential frequency offset values. For example, in FIG. 22, the offset estimation unit 506 selects the potential frequency offset value “3.0×10¹⁰” (step S206). The compensation unit of the demodulation unit compensates for the frequency offset on the basis of the selected frequency offset value (step S207).

Next, an example of dependency of a power difference on an FFT size will be described.

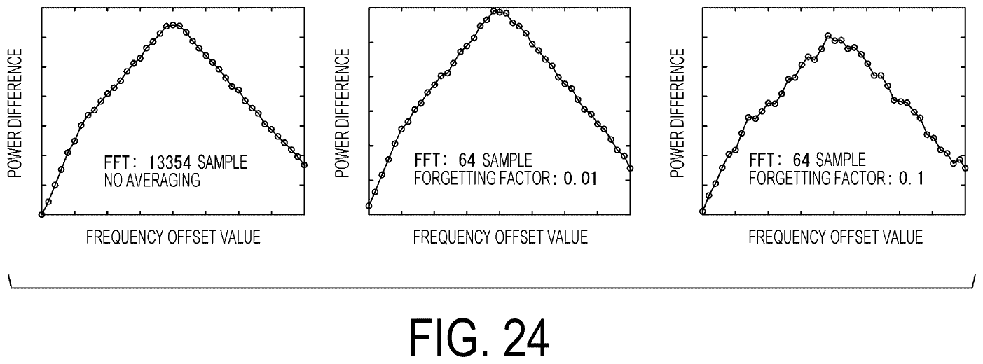

FIG. 24 shows an example of the dependency of the power difference on the FFT size (the number of samples) in the seventeenth embodiment. Fluctuation in the power difference is more stable as the FFT size in the fast Fourier transform to be applied to a received signal increases. Further, as the FFT size increases, a size of the frequency component or time component to be averaged decreases.

However, a mounting cost increases as the FFT size in the fast Fourier transform increases. Further, a time until the estimated value of the frequency offset value is derived increases as the size (averaging number) of the frequency component or time component to be averaged increases. Therefore, the mounting cost for the FFT size and the averaging number and an estimation time are determined such that estimation accuracy of the frequency offset value is equal to or larger than predetermined accuracy.

In FIG. 24, for example, a data table of “FFT: 64 samples” and “forgetting factor: 0.01” is adopted as a data table for estimating the frequency offset value such that the fluctuation in the power difference is sufficiently stable and the size of the frequency component or time component to be averaged is sufficiently small.

Next, an example of a data table (highly reliable data table) for each roll-off value of a Nyquist filter will be described.

As a shape of the power spectrum is limited according to a band characteristic of an optical device and an electrical device and roll-off of the Nyquist filter, a degree of dependency of a data table in which the frequency offset value and the power difference are associated with each other on the FFT size increases.

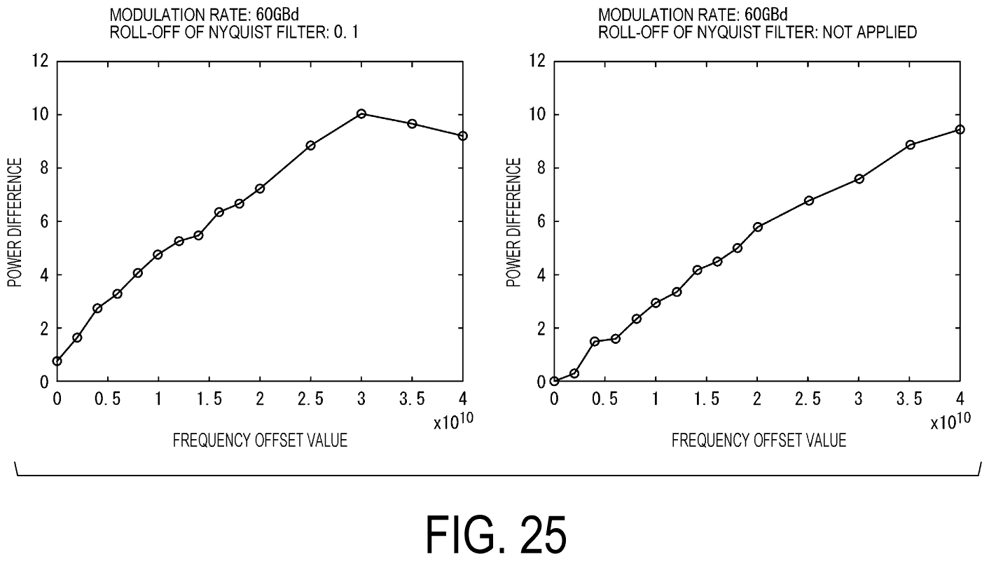

FIG. 25 shows an example of the data table for each roll-off value of the Nyquist filter in the seventeenth embodiment. Even if the same device is used for communication, data in the data table may be different depending on a shape of a waveform of a received signal. Therefore, the data table is desirably created by using a signal of a format actually used for estimating the frequency offset value.

FIG. 25 shows data tables created on the basis of different conditions. Those data tables are the same in that the frequency offset value decreases as the power difference decreases.

Therefore, even in a case where any of the data tables is used, the frequency offset can be made sufficiently small by repeating the estimation processing and the compensation processing until the power difference becomes sufficiently small.

As described above, in a case where there is a plurality of potential frequency offset values, the compensation unit compensates for the frequency offset of the received signal on the basis of a predetermined offset value. In a case where the first power difference based on the frequency component or the second power difference based on the time component decreases, the offset estimation unit 506 selects a smaller frequency offset value from the potential frequency offset values as a frequency offset value to be used for compensation. In a case where the first power difference based on the frequency component or the second power difference based on the time component increases, the offset estimation unit 506 selects a larger frequency offset value from the potential frequency offset values as the frequency offset value to be used for compensation.

This makes it possible to estimate wide frequency offset generated in a frequency of a received signal by using a reception device having a simple configuration.

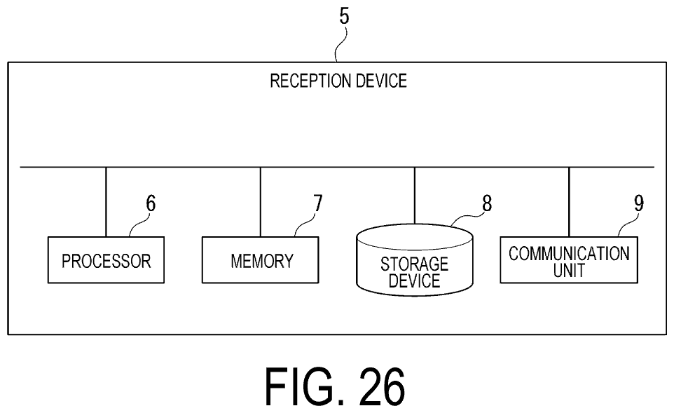

(Hardware Configuration Example) FIG. 26 shows a hardware configuration example of the reception device 5 in each embodiment. The reception device 5 (communication device) includes a processor 6. A processor 6 such as a central processing unit (CPU) executes a program stored in a storage device 8 and a memory 7 including a nonvolatile recording medium (non-transitory recording medium) and thus is implemented as software. The program (computer program) may be recorded in a computer-readable non-transitory recording medium. The program may be a multi-threaded program. The computer-readable non-transitory recording medium is a non-transitory recording medium such as a portable medium including, for example, a flexible disk, a magneto-optical disk, a ROM (read only memory), and a CD-ROM (compact disc read only memory) or a storage device such as a hard disk built in a computer system. A communication unit 9 performs predetermined communication processing.

At least some of the functional units of the reception device 5 may be an analog circuit or a digital circuit. The reception device 5 may be implemented by using hardware including an electronic circuit (or circuitry) using, for example, an LSI (large scale integrated circuit), an ASIC (application specific integrated circuit), a PLD (programmable logic device), or an FPGA (field programmable gate array). The same applies to a hardware configuration example of the transmission device 2.

Although the embodiments of the present invention have been described in detail with reference to the drawings, the specific configuration is not limited to the embodiments and includes design and the like within the scope of the present invention.

### INDUSTRIAL APPLICABILITY

The present invention can be applied to optical communication systems.

### REFERENCE SIGNS LIST

Reference Signs List

| | |
|---|---|
| 1a | Communication system |
| 2 | Transmission device |
| 3 | Optical fiber |
| 4 | Amplifier |
| 5 | Reception device |
| 6 | Processor |
| 7 | Memory |
| 8 | Storage device |
| 9 | Communication unit |
| 21 | Interface |
| 22 | Transmission signal processing unit |
| 23 | Modulator driver group |
| 24 | Optical transmitter |
| 51 | Optical receiver |
| 52 | Transimpedance amplifier group |
| 53 | Received signal processing unit |
| 54 | Interface |
| 221 | Framer |
| 222 | Error correction coding unit |
| 223 | Modulation unit |
| 224 | Digital-to-analog converter group |
| 241 | Laser diode |
| 242 | X-polarization optical converter |
| 243 | Y-polarization optical converter |
| 244 | Polarization beam combiner |
| 500 | Fast Fourier transform unit |
| 501a, 501b, 501c, 501d, 501i, 501j, 501k, 501l | Positive band-pass filter |
| 502a, 502b, 502c, 502d, 502i, 502j, 502k, 502l | Negative band-pass filter |
| 503a, 503b, 503c, 503d, 503e, 503f, 503g, 503h, 503i, 503j, 503k, | Power derivation unit |
| 503l, 503m, 503n, 503o, 503p | |
| 504a, 504b, 504c, 504d, 504e, 504f, 504g, 504h | Power derivation unit |
| 505 | Difference derivation unit |
| 506 | Offset estimation unit |
| 507a, 507c, 507e, 507g, 507i, 507k, 507m, 507o | Compensation unit |
| 508 | Signal demodulation unit |
| 509e, 509f, 509g, 509h, 509m, 509o, 509p | Positive shift unit |
| 510e, 510f, 510g, 510h, 510m, 510o, 510p | Negative shift unit |
| 511 | Local oscillator |
| 512 | Signal extraction circuit |
| 513 | Detector |
| 514e, 514f, 514g, 514h | Low-pass filter |
| 515e, 515f, 515g, 515h | Low-pass filter |
| 516i, 516j, 516k, 516l, 516m, 516n, 516o, 516p | Switch |
| 517m, 517n, 517o, 517p | Low-pass filter |
| 531 | Analog-to-digital converter group |
| 532a, 532b, 532c, 532d, 532e, 532f, 532g, 532h, 532i, 532j, 532k, | Demodulation unit |
| 532l, 532m, 532n, 532o, 532p | |
| 533 | Error correction decoding unit |
| 534 | Framer |
| 600b, 600d, 600f, 600h, 600j, 600l, 600n, 600p | Laser frequency |
| | control unit |

1. An estimation device comprising:
a difference derivator that derives a first power difference between a positive frequency component and a negative frequency component of a received signal or derives a second power difference between a positive time component and a negative time component of the received signal; and
an offset estimator that estimates a frequency offset value of the received signal on the basis of the first power difference or the second power difference.

2. The estimation device according to claim 1, further comprising
a compensator that compensates for frequency offset of the received signal by using the frequency offset value.

3. The estimation device according to claim 2, wherein:
in a case where there is a plurality of potential frequency offset values, the compensator compensates for the frequency offset of the received signal on the basis of a predetermined offset value; and
in a case where the first power difference or the second power difference decreases, the offset estimator selects a smaller frequency offset value from the potential frequency offset values as the frequency offset value to be used for compensation, and
in a case where the first power difference or the second power difference increases, the offset estimator selects a larger frequency offset value from the potential frequency offset values as the frequency offset value to be used for compensation.

4. An estimation method performed by an estimation device, the estimation method comprising:
deriving a first power difference between a positive frequency component and a negative frequency component of a received signal or deriving a second power difference between a positive time component and a negative time component of the received signal; and
estimating a frequency offset value of the received signal on the basis of the first power difference or the second power difference.

5. A non-transitory computer readable medium which stores a program for causing a computer to execute:
a procedure of deriving a first power difference between a positive frequency component and a negative frequency component of a received signal or deriving a second power difference between a positive time component and a negative time component of the received signal; and
a procedure of estimating a frequency offset value of the received signal on the basis of the first power difference or the second power difference.
